(19) United States
(12) Patent Application Publication
(10) Pub. No.: US 2018/0243756 A1
(43) Pub. Date: Aug. 30, 2018

(54) VARIABLE FREQUENCY EDDY CURRENT METAL SORTER

(71) Applicant: UNIVERSITY OF UTAH RESEARCH FOUNDATION, Salt Lake City, UT (US)

(72) Inventors: Raj Rajamani, Salt Lake City, UT (US); Felix Alba, Draper, UT (US); David Cohrs, South Jordan, UT (US); Swomitra Mohanty, Salt Lake City, UT (US); Manoranjan Misra, Salt Lake City, UT (US); Swadhin Saurabh, South Jordan, UT (US); Nakul Dholu, Salt Lake City, UT (US); James Nagel, Cottonwood Heights, UT (US); Jacob Salgado, Kaysville, UT (US)

(21) Appl. No.: 15/756,535

(22) PCT Filed: Sep. 9, 2016
(86) PCT No.: PCT/US2016/051124

§ 371 Date: Feb. 28, 2018

Related U.S. Application Data
(60) Provisional application No. 62/300,429, filed on Feb. 26, 2016.
(60) Provisional application No. 62/217,005, filed on Sep. 10, 2015.

(51) Int. Cl. B03C 1/247; B03C 1/253; B07C 5/344; B03C 1/16

(52) U.S. Cl. CPC B03C 1/247; B03C 1/253; B03C 2201/20; B03C 1/16; B07C 5/344

(57) ABSTRACT

Technology is described for an electromagnetic apparatus and system that sorts different electrically conductive metals. In one example, an electrodynamic sorting circuit includes a wire-wound, gapped, core (WWGC) and a capacitor bank. The WWGC includes a magnetic core including a gap, and an electrical conductor coiled around the magnetic core. A current in the electrical conductor is configured to generate a magnetic field in the magnetic core and the gap. The capacitor bank is coupled in series with the electrical conductor of the WWGC. Various other circuitries, systems, devices, components, and methods are also disclosed.

### RELATED APPLICATIONS

This application claims the benefit of U.S. Patent Application No. 62/217,005, filed on Sep. 10, 2015, and U.S. Patent Application No. 62/300,429, filed on Feb. 26, 2016, the contents of both of which are incorporated herein by reference.

### GOVERNMENT SUPPORT

This invention was made with government support under Grant DE-AR0000411 awarded by the Department of Energy. The government has certain rights in the invention.

### FIELD OF THE INVENTION

The invention relates to an electromagnetic apparatus and system that sorts different electrically conductive substantially non-ferrous metals, including alloys, from each other and sorts different electrically conductive substantially non-ferrous metals from electrically non-conductive materials.

### BACKGROUND

There are many occasions in scientific and industrial applications where materials need to be separated from one another. For example, in the mining industry, valuable metals need to be efficiently separated from other materials which are found in the ore. In the scrap metal industry, mixed metals (e.g, copper and aluminum) need to be separated into pure compositions. Even alloys (e.g., aluminum alloys) often need to be separated from other alloys.

In many industrial applications, separation of particles having different sizes and densities relies on the earth's gravity as well as some additional process, such as filtration. Arrangements which have been devised utilizing gravity to separate particles of different densities include various drawbacks. For example, such arrangements may require water as a carrier for the particles to be separated. After separation, the water needs to be removed from the particles. Moreover, in some mining and scrap metal operations, water is not readily available. Liquid separation methods also have additional costs with the chemicals involved and environmental concerns.

In order to provide efficient separation without water, various apparatus and techniques have been proposed which also utilize some electromagnetic properties of materials, rather than density alone, to separate materials. While the task of separating magnetic materials from nonmagnetic materials is relatively straightforward, the task of separating nonmagnetic materials from other nonmagnetic materials utilizing the magnetic properties of the materials has various challenges. The technology (systems, devices, and methods) described herein resolves many of the challenges of separating nonmagnetic materials from other nonmagnetic materials.

### SUMMARY

In one embodiment, the invention provides a variable frequency eddy current sorter technology that provides a means of sorting substantially non-ferrous metals from other non-ferrous. Unlike present eddy current sorters that use mechanical rotation to spin a collection of permanent magnets, the technology described herein utilizes a stationary magnet excited by an alternating electric current. The technology described herein is capable of sorting nonferrous particles with sizes as low as 1.0 mm, including such metals as copper (Cu), aluminum (Al), zinc (Zn), brass (Cu and Zn alloy), magnesium (Mg), and titanium (Ti). The technology is capable of separating many combinations of nonferrous metal from other nonferrous metal, for example copper from aluminum, copper from brass, or aluminum from titanium. Finally, the technology can even separate nonferrous metals by alloy, for example aluminum 5052 from aluminum 6061.

In an example, an electrodynamic sorting circuit includes a wire-wound, gapped core (WWGC) and a capacitor bank. The capacitor bank may be coupled in series with the electrical conductor of the WWGC and excited to resonance. The WWGC includes a magnetic material (e.g., the WWGC is a magnetic toroid) and has a gap where particles of material are fed for separation. A current in the electrical conductor generates a magnetic field in the magnetic core and the gap, which excites the particles for magnetic separation.

In another configuration, an eddy current sorter includes a wire-wound, gapped, core (WWGC) with windings concentrated primarily near the gap. Nonlinearities in the magnetic core material are thus circumvented for greater field strength in the gap.

In another configuration, an eddy current sorter includes a wire-wound, gapped, core (WWGC) having a multiple-cut gap. The multiple-cut gap provides a more precise, engineered force profile.

Other aspects of the invention will become apparent by consideration of the detailed description and accompanying drawings.

### BRIEF DESCRIPTION OF THE DRAWINGS

FIG. 1 illustrates a magnetic field (B-field) in a top view of a magnetic core.

FIG. 2 illustrates an eddy current in a conductive particle in a cross sectional view of the magnetic core along section line A-A of FIG. 1.

FIG. 3 illustrates a system diagram of an eddy current sorter.

FIG. 4 illustrates a second system diagram of an eddy current sorter.

FIG. 5 illustrates a perspective views of an eddy current sorter.

FIG. 6 illustrates a component view of an eddy current sorter.

FIG. 7 illustrates a capacitor bank capable of being used as the tuning capacitor.

FIG. 8 illustrates a top view of a wire-wound, gapped, core (WWGC) with toroidal winding of electrical wire, driven by the peak electrical current I₀.

FIG. 9 illustrates a schematic diagram of series RLC circuit depicting a configuration of variable frequency eddy current sorting (VFECS) drive electronics.

FIGS. 10A-10C illustrate trajectories of materials with various conductivity ranges using the eddy current sorter.

FIG. 11 illustrates a top view of a diagram of a core gap of a toroid.

FIG. 12 illustrates a graph of a simulated magnetic field (B-field) as a function of drive current for a nickel-zinc (NiZn) ferrite core.

FIG. 13A, 13B illustrate graphs showing the relation between power loss and hysteresis loop area.

FIG. 14 illustrates a graph of a simulated magnetic field (B-field) profile through the core as a function of magnetic permeability.

FIG. 15 illustrates an outline view of a flare of a core gap a magnetic toroid with a sphere to be sorted.

FIG. 16 illustrates a top view of a diagram of a core gap angle of a magnetic toroid with a sphere to be sorted.

FIG. 17 illustrates a top view of a magnetic toroid including a circular sector core gap with a core gap angle.

FIG. 18 illustrates a top view of a magnetic toroid including a circular sector core gap with a radius equal to the outside radius of the magnetic toroid.

FIG. 19 illustrates a top view of a magnetic toroid including a circular sector core gap with a radius greater than the outside radius of the magnetic toroid.

FIG. 20 illustrates a top view of a magnetic toroid including a circular sector core gap with a radius less than the outside radius of the magnetic toroid.

FIG. 21 illustrates a top view of a diagram of a core gap angle with a flare of a magnetic toroid for an eddy current sorter with a sphere.

FIG. 22 illustrates a front view of a diagram of a flare angle of a core gap of a magnetic toroid for an eddy current sorter with a sphere.

FIG. 23 illustrates a top view of a gapped magnetic core with a V-cut. The inner radius is set to 12 cm with an outer radius of 18 cm for the example shown.

FIG. 24 illustrates magnetic field and mechanical force profiles down the center of the V-cut gap. The vertical lines indicate inner radius and outer radius. (a) shows magnetic field profile; (b) shows corresponding force profile.

FIG. 25 illustrates a top view of a gapped magnetic core with multiple cuts.

FIG. 26 illustrates magnetic field and mechanical force profiles down the center of the 3-cut gap. The vertical lines indicate inner radius and outer radius. (a) shows magnetic field profile; (b) shows corresponding force profile.

FIG. 27 illustrates a top view of a wire-wound, gapped, core (WWGC) with two coils of electrical wire, driven by the peak electrical current I₀.

FIG. 28 illustrates a schematic diagram of series RLC circuit with two coils depicting a configuration of variable frequency eddy current sorting (VFECS) drive electronics.

FIG. 29 illustrates a gapped magnetic core with 150 wire turns in a uniform winding configuration.

FIG. 30 illustrates a gapped magnetic core with forward windings around the gap.

FIG. 31 illustrates a field profile under the front-winding configuration.

FIG. 32 illustrates saturation profiles for various winding configurations.

FIG. 33 illustrates a magnetic field intensity within a gap as a function of swath angle of the winding.

FIG. 34 illustrates a gapped magnetic core with a different cross-section configuration.

FIG. 35 illustrates a cross sectional view of a magnetic core encased for protection and/or cooling. A portion of the core is exposed for better sorting operation.

FIG. 36 illustrates a cross sectional view of a magnetic core encased for protection and/or cooling. No portion of the core is exposed for complete protection of the core.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Numbers provided in flow charts and processes are provided for clarity in illustrating steps and operations and do not necessarily indicate a particular order or sequence.

Eddy current sorting provides an electrodynamic mechanism to sort non-ferrous metals, which can provide a light metal and alloy sorting technology for the recycling industry. An eddy current indicates the electrical currents that are induced on electrically conductive materials due to the presence of a time-varying magnetic field. Eddy current sorting, also called electrodynamic sorting, can employ an eddy current separator or electrodynamic separator that uses a powerful magnetic field to separate non-ferrous metals from each other. A ferrous material generally refers to a generic ferromagnitc/ferrimagnetic material (i.e., ferrites), and is not limited just to iron alloys. Eddy current separators are typically not designed to sort ferrous metals because the ferrous metals are easily sorted by other means and tend to overheat inside the eddy current field. For example, ferrous or ferromagnetic materials are strongly attracted by magnetic fields. Thus, separating ferrous or ferromagnetic materials is relatively straightforward because these ferrous or ferromagnetic materials can be pulled out of scrap material with a permanent magnetic field.

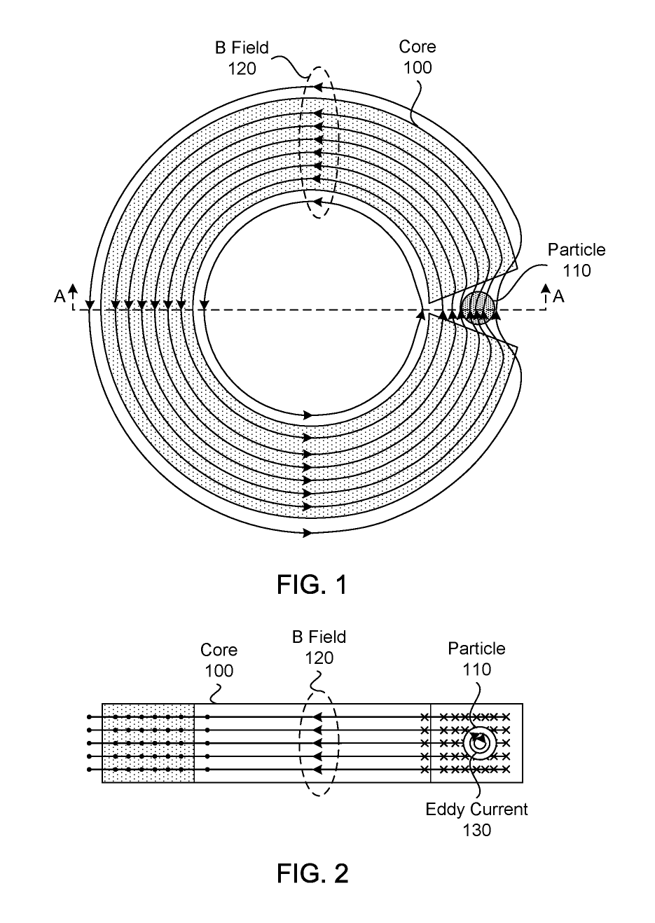

FIGS. 1 and 2 illustrate a magnetic field (B-field) 120 of a wire-wound, gapped, core (WWGC) 100 with a magnetic core generating an eddy current 130 on a particle 110 (e.g., material being sorted). Eddy currents, also called Foucault currents, are electric currents induced within conductors (e.g., metals) by a changing magnetic field in the conductor in accordance with Faraday's law of induction. Eddy currents flow in closed loops within conductors (e.g., scrap particles) in planes perpendicular to the magnetic field (B-field). The eddy currents can be induced within nearby conductors either by a time-varying magnetic field, for example by an alternating current (AC) electromagnet, or by relative motion through a static magnetic field. The magnitude of the eddy current in a given loop, in some arrangements, is dependent upon the strength of the magnetic field (B), the area of the loop, and the rate of change (i.e., frequency) of magnetic flux (Φ), and the resistivity (p) of the material.

Variable Frequency Eddy Current Sorter

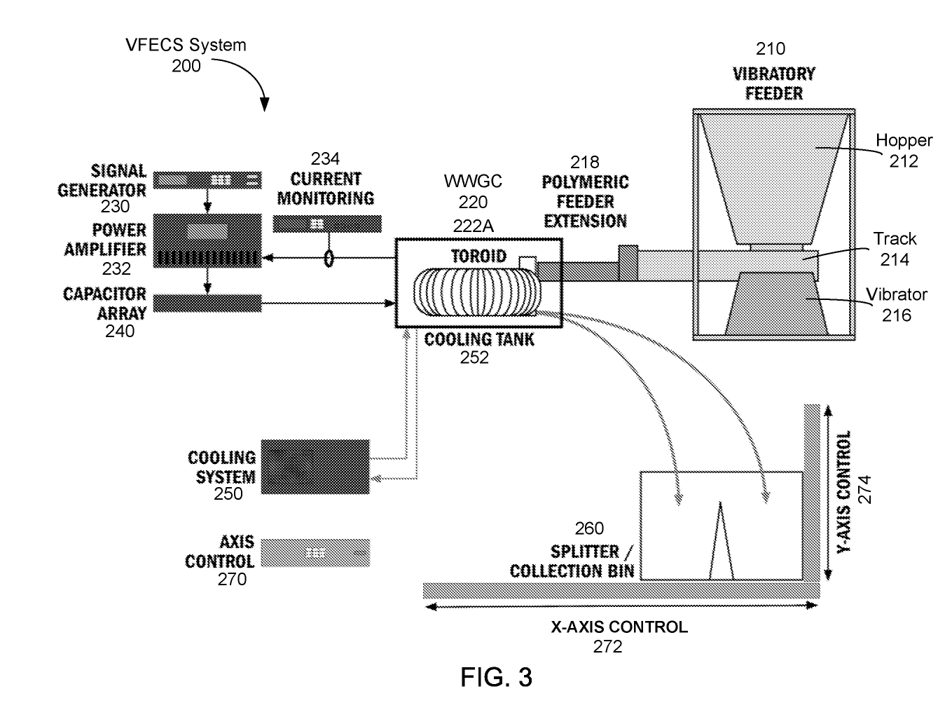

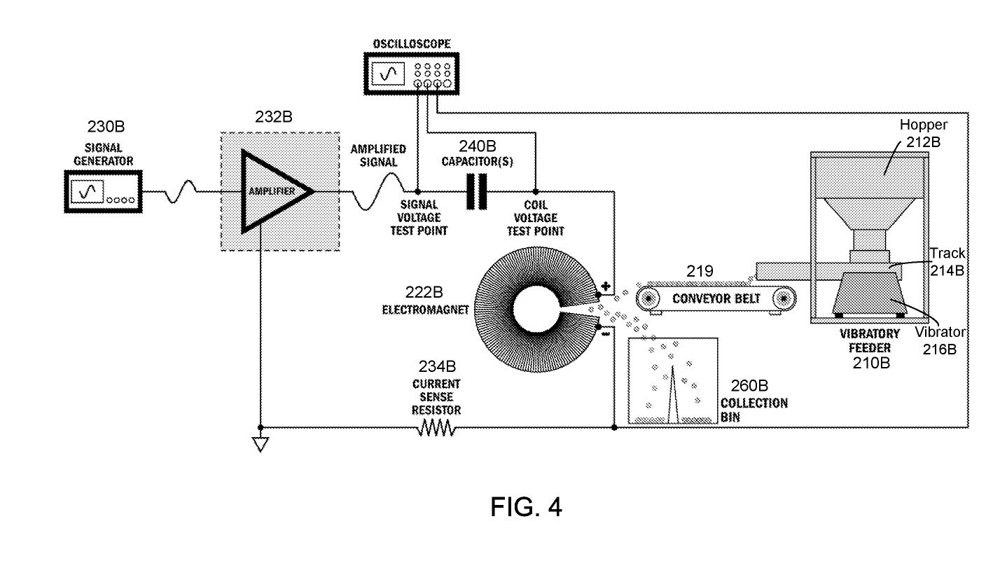

A variable frequency eddy current separator (or sorter) is a type of eddy current separator that provides greater granularity and functionality in the types of materials that can be sorted. FIG. 3 illustrates a general configuration of a variable frequency eddy current sorting (VFECS) system 200. FIG. 4 illustrates a second general configuration of a VFECS 200B. The VFECS system 200 includes a vibratory feeder 210 to receive the material to be sorted, a WWGC 220 to deflect the material based on characteristics of the material, a signal generator 230 to generate a signal at a specified frequency, a power amplifier 232 to amplify the signal, a capacitor bank 240 to tune the WWGC 220 to a desired or resonant frequency, a cooling system 250 to remove the heat generated by the WWGC 220, a splitter/collection bin 260 to collect the deflected material, and an axis control system 270 to adjust the splitter/collection bin 260 to various distances (i.e., x-axis), heights (i.e., y-axis) and angles (i.e., rotation) based on the material being sorted and the frequency of the generated signal. The VFECS system 200B of FIG. 4 includes numerous similar elements to the VFECS system 200.

The vibratory feeder 210 includes a hopper 212, a track 214, a vibrator 216, and a non-conductive feeder extension (e.g., polymeric feeder extension 218). The hopper 212 receives, holds, and funnels material (e.g., electrically conductive metals or particles) to the track 214, which provides a narrow flow or stream of material to an opening or gap in the WWGC 220. The track can also be referred to as a pan, skirt, or skirt taper. A vibrator 216 vibrates the track so the materials separate from each other, funnels the material even further, and/or moves the material towards the gap in the WWGC 220. The track 214 or the vibrator 216 supporting the track 214 can be angled at a decline from the hopper entry (input) end to the exit (output) end so the force of gravity helps to move the material to the WWGC 220.

The vibratory feeder 210B includes a hopper 212B, a track 214B, a vibrator 216,B and a conveyer 219. Similar to above, the hopper 212B receives, holds, and funnels material (e.g., electrically conductive metals or particles) to the track 214B, which provides a narrow flow or stream of material to an opening or gap in the WWGC 220 via the conveyer 219.

The shown WWGC 220 in FIG. 3 includes a magnetic toroid 222A with an opening or gap and an electrical conductor (e.g., insulated wire) coiled around the magnetic toroid 222A. A current in the electrical conductor generates a magnetic field in the magnetic toroid 222A that extends into the gap. As electrically conductive particles fall into the gap, the alternating magnetic fields induce eddy currents within them. In turn, these eddy currents experience a net force due to the presence of the applied magnetic field, causing the particles to deflect from the magnetic toroid 222A. The strength of the deflection force, and thus the trajectory of deflection, varies in accordance with such parameters as particle geometry, electrical conductivity, and frequency.

Although a gapped magnetic core used in the WWGC is shown in the various examples with toroid 222A, other volumes and geometries can also be used, such as an elliptic cylinder with an elliptic hole, an elliptic torus, a rectangular cuboid with a rectangular hole (e.g., a square cuboid with a square hole), or a rectangular prism with a rectangular hole. The gap can be placed at other locations in the magnetic core.

Referring back to FIG. 3, the material is collected and sorted in a collection bin with a splitter 260 or multiple collection bins. The splitter/collection bin can be moved to/at various distances (i.e., x-axis) and/or to/at different heights (i.e., y-axis) based on the trajectories the deflected material being sorted using an axis control system 270 that has at least a x-axis control 272 for moving the splitter/collection bin horizontally and a y-axis control 274 for moving the splitter/collection bin vertically. Further, the splitter/collection bin can be moved to/at various angles for better control in some embodiments.

The signal generator 230 generates a signal with a specified frequency for the WWGC 220. The power amplifier 232 amplifies the current and/or voltage of the signal from the signal generator 230 and drives the amplified signal to the capacitor array 240 and the WWGC 220. A capacitance of the capacitor array 240 is adjusted based on an inductance of the magnetic toroid 222A and specified frequency for sorting. The capacitance (C) and inductance (L) forms a resonant circuit (LC circuit or RLC circuit) with a resonant frequency given by f=1/(2π\sqrt{LC}). The current monitor 238 is used to monitor the current in the electrical conductor of the WWGC 220. In some constructions, a square wave voltage source, for example, with a power inverter can be used to generate the amplified signal to the capacitor array. The RLC circuit provides a natural band-pass filter that will only allow the fundamental harmonic to pass, thus resonating at the desired frequency.

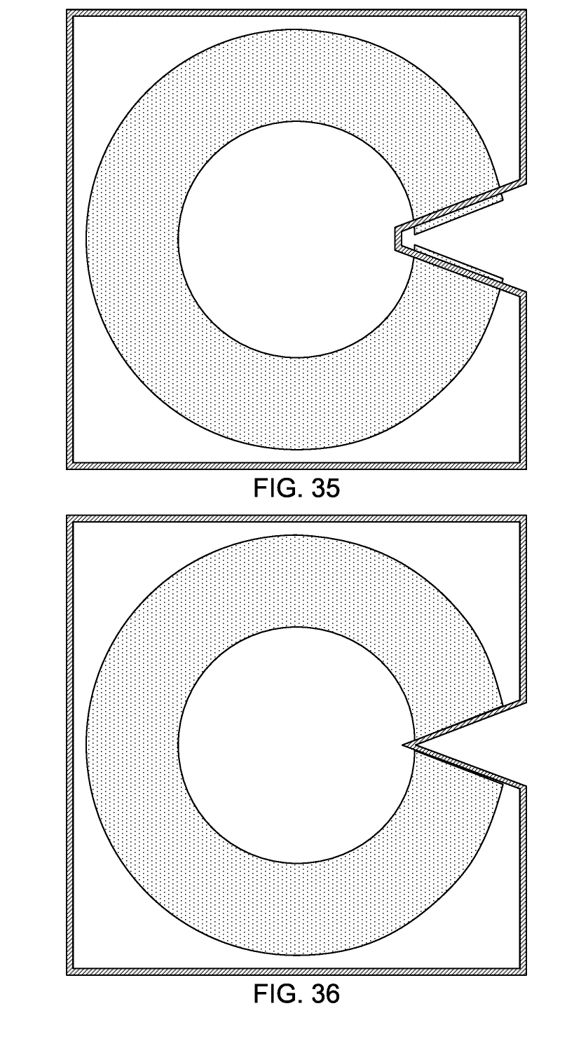

In some configurations and operational conditions, the WWGC 220 generates excess heat that can degrade performance of the WWGC 220. A cooling tank 252 can surround the WWGC 220 and house cooling fluid/gas or coolant circulated by the cooling system 250. The warmer coolant of the cooling tank 252 is exchanged for the cooler coolant from the cooling system 250. In some configurations, the cooling tank 252 can be constructed of materials that provide magnetic shielding, so the magnetic fields and magnetic flux generated from the WWGC 220 is reduced in the space outside the cooling tank 252. In other configurations, the cooling tank 252 can be constructed of non-conductive materials (e.g., non-metallic materials). FIG. 35 illustrates a cross sectional view of a magnetic core encased for protection and/or cooling. A portion of the core is exposed through the cooling tank for better sorting operation. FIG. 36 illustrates a cross sectional view of a magnetic core encased for protection and/or cooling. No portion of the core is exposed through the cooling tank for complete protection of the core.

Using non-conductive materials and components (that are not used in the WWGC) in the vicinity or close proximity (e.g., within 20 centimeters (cm)) of the WWGC 220 can reduce the interference and/or damping of the magnetic fields of the WWGC 220. In addition, the non-conductive materials in the vicinity or close proximity of the WWGC 220 will not generate eddy currents and heat associated with those eddy currents. Conductive material in close proximity to an operating WWGC 220 can generate its own eddy currents, which in turn generates additional heat and expends additional energy, which can be undesirable.

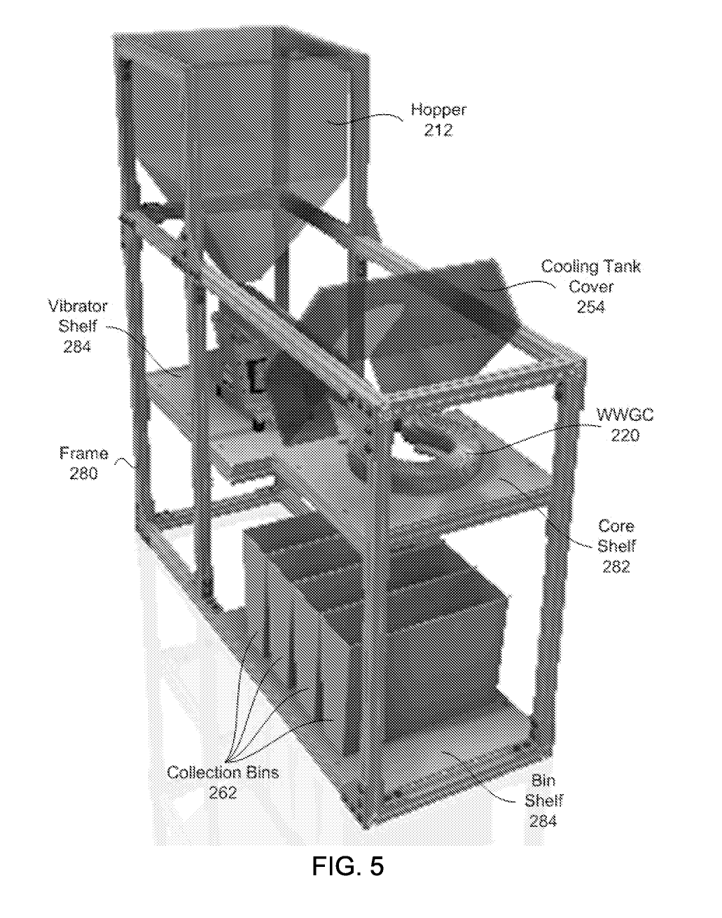

FIG. 5 illustrates a perspective views of an eddy current sorter. The eddy current sorter is supported by a frame 280 (or rack) with multiple shelves 282, 284, and 286. The frame can also support other components, such as the hopper 212. The frame 280 includes multiple horizontal components and multiple vertical components coupled together with brackets, bolts, and/or other fastening or attachment means (e.g., welding or adhesives). The frame 280 and other components (e.g., shelves, brackets, and bolts) can be manufactured from steel, other metals, or non-conductive structural materials, such as polymers and plastics. The shelves 282, 284, and 286 can have different heights and positions on the frame based on their functions. The core shelf 282 supports the WWGC (core) 220 and the cooling tank cover 254, the vibrator shelf 284 supports the vibrator, and the bin supports the collection bins 262 and/or the axis control components (not shown). The core shelf 282 includes an opening 288 which allows material to fall into collection bins below the core shelf 282.

The collection bins can include containers, receptacles, or rectangular boxes with one side being open for collecting sorted or deflected material. The collection bins can be manufactured from steel, other metals, or non-conductive structural materials, such as polymers and plastics. FIG. 5 show four collection bins. Each of the collection bins can be positioned to collect different types of material with a specified trajectory for the WWGC 220 and signal frequency. In other configurations, a single collection bin may be used to collect the sorted or deflected material. In some examples, the single collection bin includes a splitter or divider to separate material in the collection bin. In other configurations, conveyors can be used in addition to or alternatively to collection bins. The conveyors can be used to move the material to a collection bin, collection pile, and/or another sorting process (e.g., VFECS WWGC), such as in-tandem WWGCs for further sorting of the material.

Variable Frequency Eddy Current Sorter Circuit

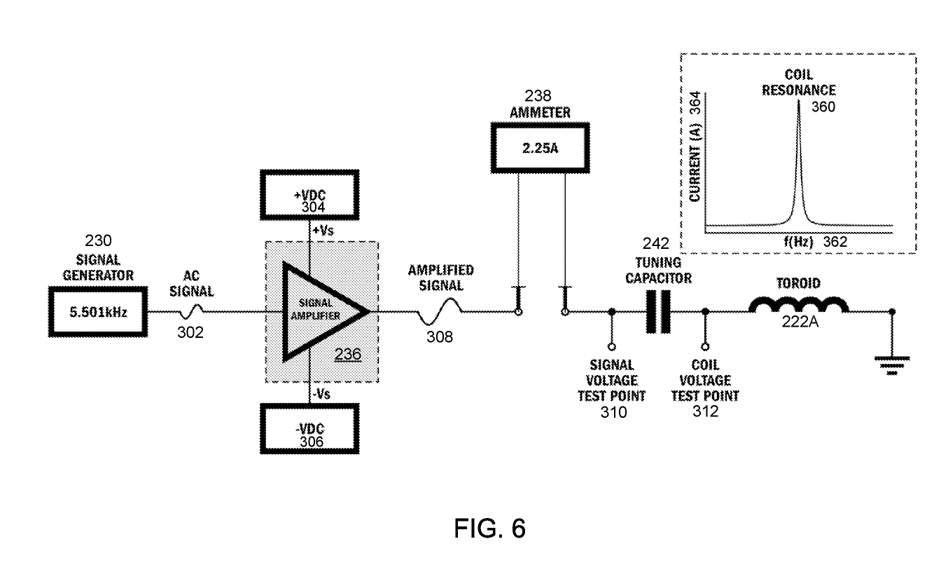

FIG. 6 illustrates a schematic diagram of a variable frequency eddy current sorter (VFECS) circuit or VFECS drive electronics. The electrical components of an exemplary variable frequency eddy current sorter include the signal generator 230, the signal amplifier 236 coupled to a positive direct current (DC) power supply (+VDC) 304 and a negative DC power supply (−VDC) 306, an ammeter 238, a tuning capacitor 242, and a magnetic toroid 222A. As previously discussed, the signal generator 230 generates an AC signal 302 with a specified frequency (e.g., 5.501 kHz). A signal amplifier 236 amplifies the signal 308 (i.e., current and/or voltage magnitude). At least one signal amplifier 236, the positive DC power supply 304, and the negative DC power supply 306 can be included in the power amplifier (232 of FIG. 3). The ammeter 238 measures the current (e.g., 2.25 amperes (A)) of the amplified signal. The variable frequency eddy current sorter circuit can also have various voltage test points, such as the signal voltage test point 310 and the coil voltage test points 312. The current measurements from the ammeter and the voltage measurements from the voltage test points can be used to monitor the current and voltage of the tuning capacitor 242 and the magnetic toroid 222A, which can be used as feedback for the signal generator 230 and power amplifier 232.

The signal generated by the signal generator can have different waveforms, such as a sinusoidal wave (or sine wave), a square wave, a triangle wave, or sawtooth wave. While a sinusoidal wave is considered simple and ideal, it can also potentially require costly, high-fidelity amplifiers to generate. In contrast, switched-mode square-wave generators can be more cost effective. In either case, the resulting current waveform is always a sinusoid, as any higher-order harmonics of the voltage waveform are filtered by the bandpass nature of the RLC circuit.

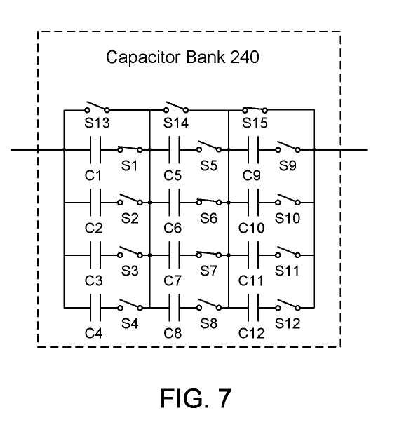

At the resonant frequency, the current 364 (in A) spikes in the variable frequency eddy current sorter circuit. The tuning capacitor 242 includes at least one high voltage capacitor (e.g., rated for greater than kilovolt (kV)), which can be used to generate resonance in the magnetic toroid 222A (e.g., resonance coil 360) at the specified frequency (f) 362 in hertz (Hz). In other examples, at least one high voltage capacitor is rated for at least 5 kV or 10 kV. The tuning capacitor can be a capacitor array (240 of FIG. 3), a capacitor bank, or a capacitor arrangement with one capacitor or a plurality of high voltage capacitors. The plurality of capacitors can be combined in series and/or parallel to generate the desired or specified capacitance. The capacitors can be coupled together with high voltage jumpers, cables, and/or switches. An exemplary capacitor bank 240 is schematically shown in FIG. 7.

Electrical resonance occurs in an electric circuit at a particular resonance frequency when the imaginary parts of impedances or admittances (i.e., the inverse of impedance) of circuit elements cancel each other. Electrical impedance is the measure of the opposition that a circuit presents to a current when a voltage is applied. Impedance includes the real part of complex impedance called resistance and the imagery part of complex impedance called reactance. Both the magnetic toroid 222A and the tuning capacitor 242 have reactance. The induction of voltages in conductors self-induced by the magnetic fields of currents (e.g., in the magnetic toroid 222A) is referred to as inductance, and the electrostatic storage of charge induced by voltages between conductors (e.g., in the tuning capacitor 242) is referred to as capacitance. Reactance applies only to AC circuits (i.e., a circuit with alternating, or time-varying, current or voltage applied).

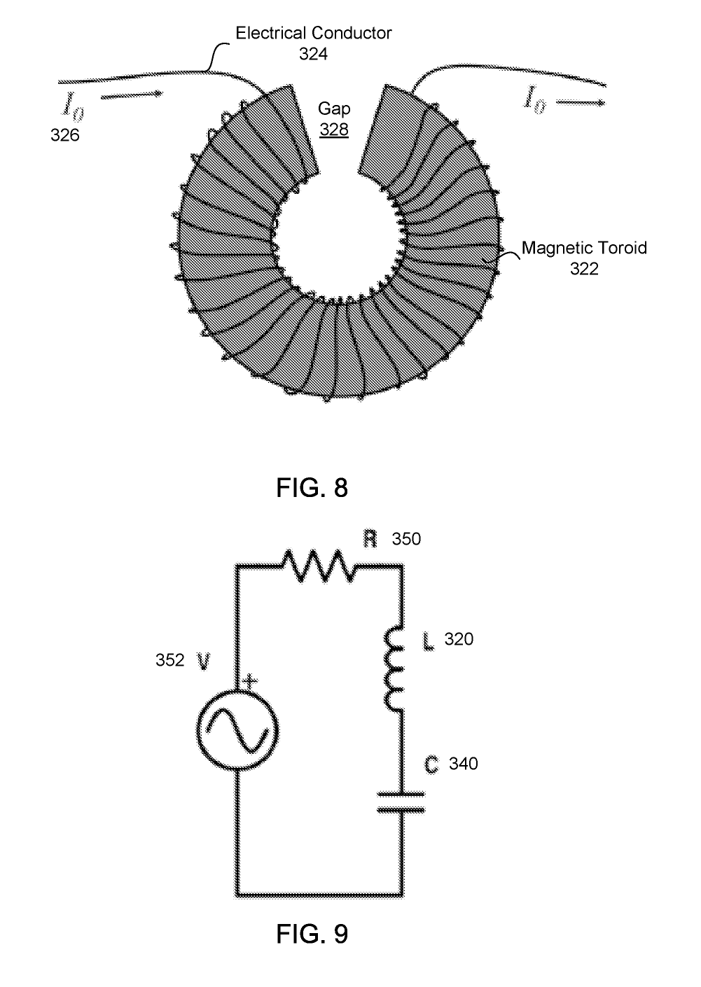

FIG. 8 illustrates a gapped magnetic core (e.g., magnetic toroid 322) of the WWGC with toroidal winding of electrical conductor 324 (e.g., electrical wire) that can be used in the variable frequency eddy current sorter. As shown in FIG. 8, the magnetic fields are typically achieved through the use of a large coil of electrical wire wrapped around a gapped magnetic core, such as a toroidal shaped core 322. When driven with electrical current I, a magnetic field (B-field) is produced within the gap 328, which is then used to excite eddy currents within conductive particles, such as particles of scrap metal.

The WWGC can be driven by voltage source 352 (or current source) using the series RLC circuit schematically represented in FIG. 9. An RLC circuit is an electrical circuit consisting of a resistor (R) 350, an inductor (L) 320, and a capacitor (C) 340, connected in series or in parallel. FIG. 9 shows the RLC circuit coupled in series. The resonance frequency (f₀ or fᵣ) or natural frequency of such a circuit is defined in terms of the impedance presented to a driving source. When excited at resonance, the reactive impedance of the capacitor negates the reactive impedance of the inductor, leaving only the real resistance of the resistor.

The VFECS circuit creates a tuned RLC circuit (or band pass filter). The inclusion of the series capacitor helps lead to resonance for the circuit. The series capacitor is a tunable capacitor bank or array 242 (FIG. 3 and FIG. 7) to generate an AC field at the desired frequency (e.g., resonant frequency). As a result, the series impedance of the RLC circuit is reduced to a predominantly real value determined by the internal resistance of the system. This allows the VFES circuit to be driven at large currents with relatively small voltages.

Deflection for the Eddy Current Sorter

The physical principle of electrodynamic sorting can best be explained by applying appropriate assumptions into Maxwell's equations and mathematically computing the results. One can begin by assuming a sinusoidal steady state solution wherein all vector quantities are expressed as phasors. This allows us to replace all time derivatives with

$$\frac{d}{dt} = j ω , ,$$

where j=\sqrt{−1} is the imaginary unit and ω=2πf is the angular frequency of excitation. One may then express Faraday's law of electromagnetic induction as

∇×E=−jωB, Eq. 1

where E is the electric field intensity and B is the magnetic field intensity. Likewise, Ampere's law in phasor form is expressed as

∇×B=μ₀J+−jωμ₀∈₀E, Eq. 2

where μ₀ is the permeability of free space, ∈₀ is the permittivity of free space, and J is the electrical current density.

The next important assumption is the quasi-static approximation, which says that the frequency of excitation is a very small value (e.g., f<100 kHz). Under such a condition, the displacement current term in Ampere's law is negligible and allows us to simply write

∇×B=μ₀J. Eq. 3

As a final assumption, one can express the total magnetic field B as a superposition of two primary fields of interest, given as

B=Bᵢ+Bₑ. Eq. 4

The Bᵢ term is called the impressed magnetic field and represents any given fields that are imposed onto a system of interest by external agents. All electrical currents that gave rise to Bᵢ are assumed to lie well beyond the region of interest, thus setting the curl of this field to zero. The Bₑ term is then called the induced field, or the eddy field, and represents any fields created by the presence of unknown electrical currents contained within J. One may therefore rewrite Ampere's law to reflect this distinction such that

∇×Bₑ=μ₀J. Eq. 5

One can then next invoke the point form of Ohm's law which relates the electric field to the conduction current density via

J=σE, Eq. 6

where σ denotes the electrical conductivity within some given material of interest. Plugging back into Ampere's law then gives

∇×Bₑ=μ₀σE, Eq. 7

We now take the curl of this expression to find

∇×∇×Bₑ=μ₀σ(∇×E). Eq. 8

The curl of a curl is a well-known vector formula that simplifies into

∇×∇×Bₑ=−∇²Bₑ+∇(∇·Bₑ). Eq. 9

From Gauss's law, one also knows that ∇·Bₑ=0 everywhere, leaving one only with

−∇²Bₑ=μ₀σ(∇×E). Eq. 10

Substituting from Faraday's law then results in

−∇V²Bₑ=−jωμ₀σ(Bₑ+Bᵢ). Eq. 11

Rearranging and simplifying finally leads one to

∇²Bₑ+k²Bₑ=−k²Bᵢ, Eq. 12

where k=\sqrt{−jωμ₀σ} is the wavenumber of the eddy field. The above expression is the well-known Helmholtz equation and can readily be solved under a wide variety of useful geometries. What it tells us is that an impressed magnetic field Bᵢ acting on a conductive object will act as a source term for the induced eddy fields in Bₑ. Once Bₑ has been derived, one may then calculate the eddy current density J by applying

∇×Bₑ=μ₀J. Eq. 13

After the eddy current density is finally calculated, we may then calculate the net force acting on a metal particle by applying the classical magnetic force law

F=∫∫∫r×JdV, Eq. 14

where r denotes a position vector in space and V denotes the spatial region occupied by the eddy currents within a conducting particle. If we then recall Newton's third law of motion,

$$a = \frac{F}{m} , \qquad Eq . 15$$

one can at last solve for the net acceleration a experienced by a metal particle of mass m as it enters a time-varying magnetic field. The result is a distinct kinematic trajectory that varies heavily with such factors as electrical conductivity, frequency of excitation, and mass density. Thus, if the disparity between metal particles is significant, it becomes possible to sort them by placing a mechanical barrier between their trajectories.

To illustrate, the electrical conductivity of copper is roughly twice that of aluminum (60 MS/m versus 35 MS/m), but the mass density is over three times greater (8.96 g/cm³ versus 2.71 g/cm³). Consequently, even if the force on a copper particle were twice as great, the net acceleration in would still be significantly less than that of aluminum. Similar disparities likewise exist between other popular mixtures of scrap metal particles, including copper and brass, aluminum and titanium, or even wrought aluminum alloys and cast aluminum alloys.

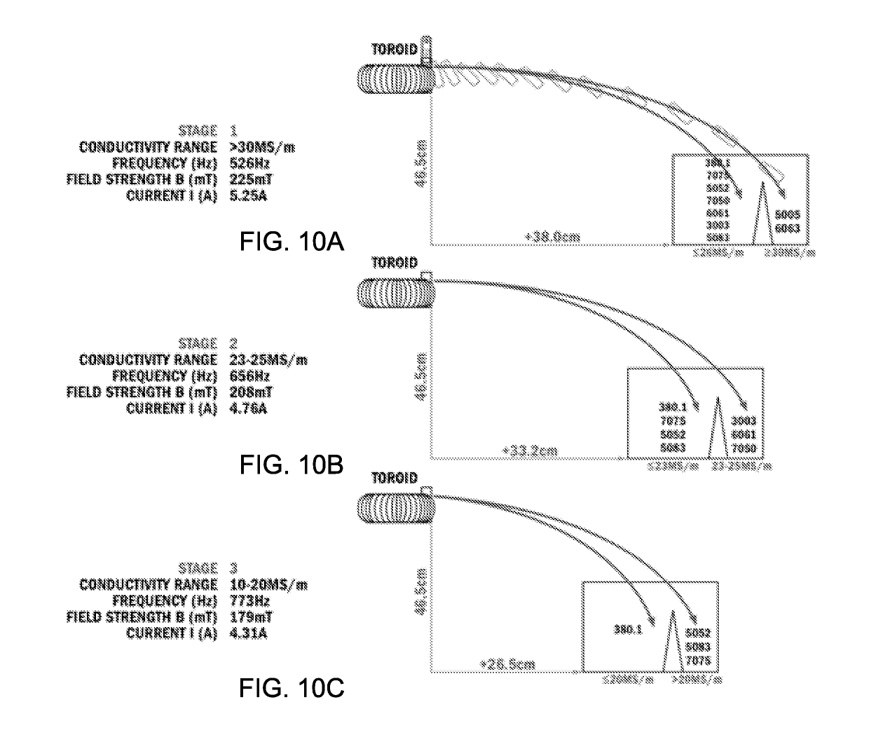

FIGS. 10A-10C illustrate trajectories of materials with various conductivity (σ) ranges using the eddy current sorter in some constructions. The disclosed number and values are exemplary and are meant for illustration. The trajectory of materials (e.g., conductive particles) is based on a deflection force generated by the VFECS circuit.

In one sorting process (i.e., stage 1 sorting process) illustrated by FIG. 10A, the frequency of the WWGC is tuned to 526 Hz with a current of 5.25 A delivering a field strength B of 225 millitesla (mT), which can sort material with conductivities that are greater than or equal to 30 Megasiemens per meter (>30 MS/m) from other materials. Pure aluminum and alloys with high concentrations of aluminum (e.g., greater than 97% Al), such as 5005 aluminum alloy and 6063 aluminum alloy, can be sorted from other materials with lower conductivities by the stage 1 sorting process.

The splitter/collection bin for the WWGC tuned for the stage 1 sorting process shown in FIG. 10A is placed 38.0 cm (x-axis) from the WWGC and 46.5 cm (y-axis) below the WWGC. The materials with conductivities less than 30 MS/m (e.g., ≤26 MS/m) fall in the section of the splitter/collection bin closest to the toroid and the materials with conductivities greater than or equal to 30 MS/m are projected in the section of the splitter/collection bin furthest from the toroid.

The alloys with conductivities ≤26 MS/m can be further sorted in a second sorting process (i.e., stage 2 sorting process) illustrated by FIG. 10B. In the stage 2 sorting process, the frequency of the WWGC is tuned to 656 Hz with a current of 4.75 A delivering a field strength B of 208 mT, which can sort material with conductivities between 23-25 MS/m (e.g., aluminum alloys 3003, 6061, and 7050) from other materials with conductivities ≤23 MS/m (e.g., aluminum alloys 380.1, 7075, 5052, and 5083).

The splitter/collection bin for the WWGC tuned for the stage 2 sorting process shown in FIG. 10B is placed 33.2 cm from the WWGC and remains at 46.5 cm below the WWGC. The materials with conductivities less than or equal to 23 MS/m (e.g., ≤23 MS/m) fall in the section of the splitter/collection bin closest to the toroid and the materials with conductivities greater than 23 MS/m are projected in the section of the splitter/collection bin furthest from the toroid.

The alloys with conductivities <20 MS/m can be further sorted in a third sorting process (i.e., stage 3 sorting process) illustrated by FIG. 10C. In the stage 3 sorting process, the frequency of the WWGC is tuned to 773 Hz with a current of 4.31 A delivering a field strength B of 179 mT, which can sort material with conductivities between 20-23 MS/m (e.g., aluminum alloys 5052, 5083, and 7075) from other materials with conductivities ≤20 MS/m (e.g., aluminum alloy 380.1).

The splitter/collection bin for the WWGC tuned for the stage 3 sorting process shown in FIG. 10C is placed 26.5 cm from the WWGC and remains at 46.5 cm below the WWGC. The materials with conductivities less than or equal to 20 MS/m (e.g., <20 MS/m) fall in the section of the splitter/collection bin closest to the toroid and the materials with conductivities greater than 20 MS/m are projected in the section of the splitter/collection bin furthest from the toroid.

The materials sorted by the processes shown in FIGS. 10A-10C have substantially uniform size and shapes. Although FIGS. 10A-10C illustrate sorting of materials into four different bins with conductivities ≥30 MS/m, 23-30 MS/m, 20-23 MS/m, and ≤20 MS/m, changes to the WWGC, the frequency, the current, the placement (height, distance of the splitter/collection bin will provide different granularity in materials (e.g., aluminum alloys) that can be sorted.

In other configurations, other types of aluminum alloys can be sorted from other types of metal alloys (e.g., copper alloys, such as brass and bronze [Cu and tin (Sn) alloy]). For example, the initial mixture of material may consist of copper and aluminum scrap, typically mixed together by shredding, but with the nonconductive materials removed. Particle sizes on the range of 1.0-3.0 cm are fairly common and may not be easily separated with traditional, rotary-based eddy current sorters.

To sort aluminum from copper in this size range, excitation frequency generally needs to be much higher, reaching upwards of 8-10 kHz or more. With an initial magnetic field intensity of 40-60 mT, aluminum particles tend to deflect much further than copper when passing through a gapped magnetic core. Starting at a height of 0.5 m, the divider between separation bins may rest between 10-20 cm, with aluminum deflecting into the furthest bin and copper dropping directly into the near bin. Specific values may generally vary, depending on specific parameters within a practical configuration.

Magnetic Cores

FIG. 8 illustrates a top view of a toroidal-shaped magnetic core with electrical conductor windings 324 for the WWGC of an eddy current sorter. The magnetic core is a piece of magnetic material with a high permeability used to confine and guide magnetic fields in electrical, electromechanical, and magnetic devices, such as electromagnets and inductors. The magnetic core is made of ferromagnetic metal such as iron, or ferrimagnetic compounds such as ferrites. The high permeability, relative to the surrounding air, causes the magnetic field lines to be concentrated in the core material, as shown in FIG. 1. The magnetic field is created by a coil of wire (i.e., windings) around the core that carries a current. Windings refer to wire or an electrical conductor wound around the magnetic core or turns around the magnetic core. The presence of the core can increase the magnetic field of a coil by a factor of several thousand over what the magnetic field would be without the core.

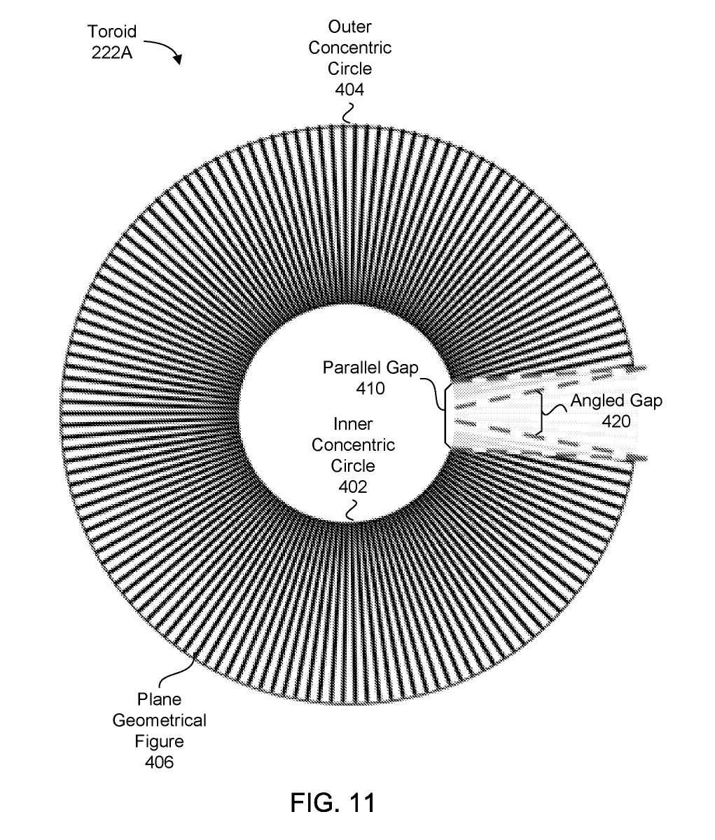

The magnetic core can have toroidal geometry. A toroid 222A is a doughnut-shaped object or ring-shaped object with a region bounded by two concentric circles (i.e., an inner concentric circle 402 and an outer concentric circle 404), as shown in FIG. 11. The toroid annular shape is generated by revolving a plane geometrical FIG. 406 about an axis external to that figure which is parallel to the plane of the figure and does not intersect the figure. The plane geometrical figure is perpendicular to the tangent of the concentric circles. The plane geometrical figure can have different shapes, such as a rectangle, circle (forming a torus), ellipse, or polygon. Although, the toroids shown in the examples (e.g., FIG. 2) have a generally rectangular shape plane geometrical figure, other shapes of toroids may also be used, including with e.g., with rounded edges or bevels, or fillets.

The toroid 222A also includes a gap or void for the conductive particle to pass. The gap can be a parallel gap 410 between substantially parallel planes or be an angled gap 420 forming an arc-like void between two non-parallel planes with a defined radius and angle. In one example, the gap of the magnetic core forms a wedged frustum-like shaped void. A frustum (plural: frusta or frustums) is the portion of a solid (e.g., cone, pyramid, or wedge) that lies between two parallel planes cutting the solid.

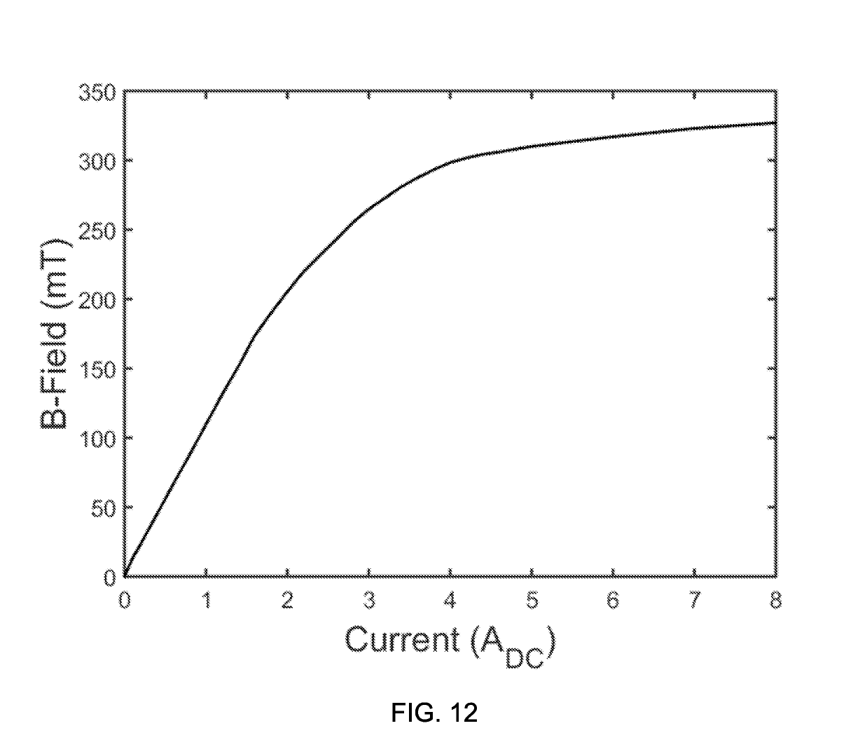

FIG. 12 shows the magnetic field (B-field) inside the gap of a typical Nickel-zinc (NiZn) ferrite core as a function of drive current through the windings. As shown, the saturation field occurs around 4-5 Amps with a B-field between 300 and 350 mT. Driving current beyond this point of saturation is therefore more-or-less futile, and does not appreciably improve the performance of the magnetic core.

The relation between the magnetizing field H and the magnetic field B can be expressed as the magnetic permeability μ=B/H or the relative permeability μᵣ=μ₀, where μ₀ is the vacuum permeability or permeability constant. Magnetic permeability is the measure of the ability of a material to support the formation of a magnetic field within itself. Hence, permeability is the degree of magnetization that a material obtains in response to an applied magnetic field. The reciprocal of magnetic permeability is magnetic reluctivity. The permeability constant (μ₀), also known as the magnetic constant or the permeability of free space. The magnetic constant has defined value μ₀=4π×10⁻⁷ H·m⁻¹≈1.2566370614 . . . ×10 ⁻⁶ H·m⁻¹ or N·A⁻²). A good magnetic core material should have high permeability (e.g., μᵣ>100).

The permeability of ferromagnetic materials is not constant, but depends on H. In materials, the relative permeability increases with H to a maximum (i.e., saturation knee or μₘₐₓ), then as the magnetization curve approaches saturation the relative permeability inverts and decreases toward one.

The magnetic core 320 (e.g., toroid 222A) includes ferromagnetic and ferrimagnetic materials. Inherent to ferromagnetic materials and ferroelectric materials is a characteristic or effect referred to as hysteresis. Hysteresis is the time-based dependence of a system's output on current and past inputs. The dependence arises because the history affects the value of an internal state. To predict the system's (e.g., magnetic cores) future outputs, either the system's internal state or the system's history needs to be known. Hysteresis occurs in the flux density B of ferromagnetic materials and ferroelectric materials in response to a varying magnetizing force H.

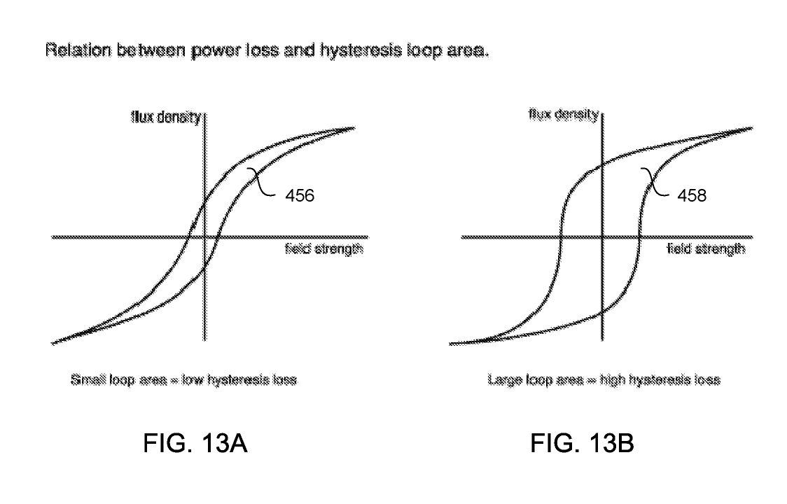

The hysteresis of a material strongly affects the material's suitability for a particular application. FIGS. 13A, 13B illustrate the relation between power loss and hysteresis loop area. FIG. 13A shows the hysteresis loop of a “soft” magnetic material, such as iron alloyed with silicon. The distance between the forward B-H curve and the reverse B-H curve is small or narrow. As a result the area 456 of the hysteresis loop is small and the hysteresis losses are small, which is beneficial for low loss magnetic core applications. FIG. 12B shows the hysteresis loop of a “hard” magnetic material, such as Alnico (an iron/cobalt/nickel/aluminum alloy) used for permanent magnets. The distance between the forward B-H curve and the reverse B-H curve is larger (than the soft magnetic material) or wide. As a result the area 456 of the hysteresis loop is large with more hysteresis losses. Cooling devices (e.g., cooling tank 252 and cooling system 250 in FIG. 3) can be used to remove the heat generated from the hysteresis losses when the heat is excessive.

Different materials have different saturation levels. For example, high permeability iron alloys used in transformers reach magnetic saturation at 1.6-2.2 Teslas (T), whereas many popular ferrites tend to saturate between 0.2-0.5 T.

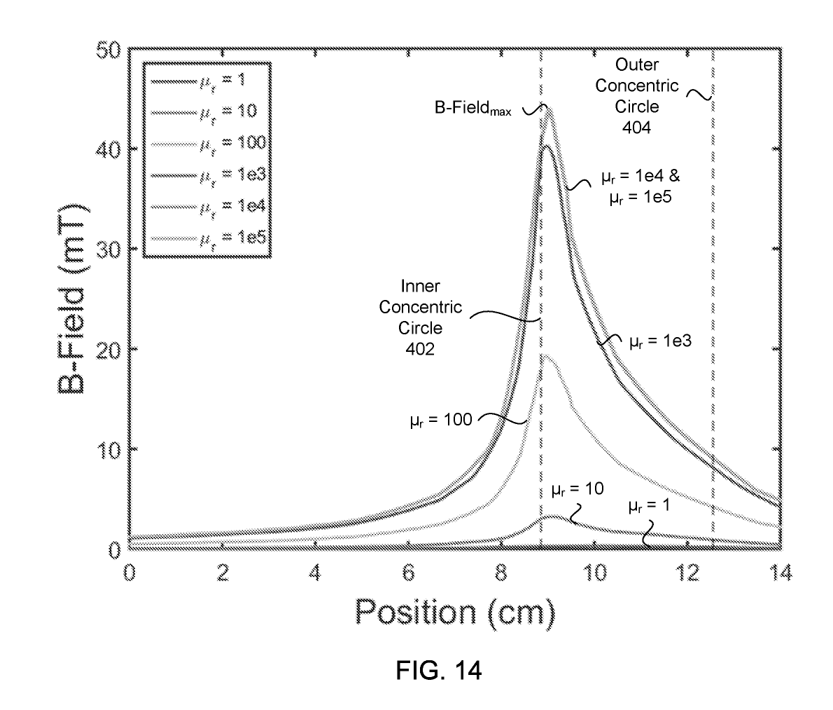

FIG. 14 illustrates a graph of a slow progression of what the field profile would look like down the center of a gapped magnetic core as one changes the magnetic permeability. At μᵣ=1, the field is created just by the coils, but no core (free space). Filling the core with materials of higher permeability then tends to focus more flux into the gap until eventually reaching a saturation threshold. As illustrated, a saturation point (i.e., B-field maximum or B-fieldₘₐₓ) exists around μᵣ=1000 (i.e., maximum useful permeability μₘₐₓ). The B-fieldₘₐₓ provides another constraint on the magnetic core and magnetic material. Additional B-field or flux density is not really generated beyond this maximum useful permeability μₘₐₓ. Thus, high permeability materials are only useful up to a specified value (e.g., >1000). Super high permeability materials (e.g., >10000) may not be worth seeking out because they do not necessarily increase the useful B-field inside the gap.

Magnetic Core Materials

The magnetic cores 320 can include various materials, such as solid metal core (e.g., a silicon steel core), a powdered metal core (e.g., carbonyl iron core), and ferrite or ceramic cores. The solid metal cores can include “soft” (annealed) iron, “hard” iron, laminated silicon steel, special alloys (specialized alloys for magnetic core applications, such as mu-metal, permalloy, and supermalloy), and vitreous metals (e.g., amorphous metal alloys [e.g. Metglas] that are non-crystalline or glassy).

Laminated silicon steel is specialty steel tailored to produce certain magnetic properties, such as a small hysteresis area (i.e., small energy dissipation per cycle or low core loss) and high permeability. Two techniques commonly used together to increase the resistance of iron, and thus reduce the eddy currents, is lamination and alloying of the iron with silicon.

Among the two types of silicon steel, grain-oriented (GO) and grain non-oriented (GNO), GO is more desirable for magnetic cores. Grain-oriented silicon steel (GOSS) core or a cold-rolled grain-oriented (CRGO) silicon steel is anisotropic, offering better magnetic properties than GNO in one direction. As the magnetic field in inductor and cores is along the same direction, it is an advantage to use grain oriented steel in the preferred orientation. Rotating machines, where the direction of the magnetic field can change, gain no benefit from grain-oriented steel, thus GNO silicon steel can be used.

The magnetic core can utilize CRGO silicon steel or GOSS for aluminum alloy sorting due to high possible field strengths with silicon steel at low operating frequencies. In one example, CRGO has a relative permeability (μᵣ) as high as 100,000 and a saturation magnetic flux density B (B_{S}, B_{Sat} or B_{Saturation}) of 2.1 T. Electrical conductivity, however, can also reach the order of 1.0 MS/m and above. Even with laminated layers to squelch eddy currents, the internal heat dissipation of a single, small-sized core might exceed 1.0 kW at frequencies above 5.0 kHz. At lower frequencies (say, <2.0 kHz), the heat dissipation is much lower and thus far more manageable through proper heat-sinking techniques.

Ferrites are another type of ferrimagnetic magnetic material that can be used for the magnetic core 320. The ferrite is both electrically nonconductive and ferrimagnetic, meaning that the ferrite can be magnetized or attracted to a magnet. Ferrites are usually non-conductive ferrimagnetic ceramic compounds derived from iron oxides such as hematite (Fe₂O₃) or magnetite (Fe₃O₄) as well as oxides of other metals.

Ferrite cores can be used for sorting mixed metals such as copper and brass from aluminum, or titanium from aluminum at moderate field strength for high operating frequencies. Ferrite cores can also be suitable for sorting aluminum alloys at low frequencies as well. Alloys require high field strengths to be generated by the magnetic cores to have the most specificity between highly similar alloys (e.g. where there is a very small difference in conductivity between materials, differences on the order of 2-5 MS/m). The conductivity/density ratio and particle size can be used determine the optimal sorting frequency. Where alloys are concerned, the densities can be nearly identical and therefore conductivity, particle size, and B field strength become the master variables in establishing the optimal sorting frequency.

Typical frequencies used for sorting metals, alloys, and various particle sizes likely to be encountered in a real world situation is 500 Hz to 50 kHz. Due to the relatively high internal resistance of silicon steel at high frequencies, silicon steel cores (e.g., GOSS or CRGO silicon steel cores) can be useful for metal and alloy sorting at low frequencies (e.g., 100 Hz-2 kHz). Ferrites tend to have much higher resistivity and thus dissipate far less heat at higher frequencies (e.g., 2-50 kHz). However, ferrites also tend to have much lower saturation fields (<0.5 T), thus imposing certain design trade-offs.

Although silicon steel and ferrites have been discussed specifically, other core materials with high flux densities (e.g., >300 mT) at both low and high frequencies may also be used for the magnetic core of an electrodynamic sorting system. Magnetic core materials can be selected based on magnet saturation characteristics (e.g., saturation flux density, B_{S}, or Bₛₐₜ) and power dissipation per unit volume.

Magnetic Core Geometry and Gap

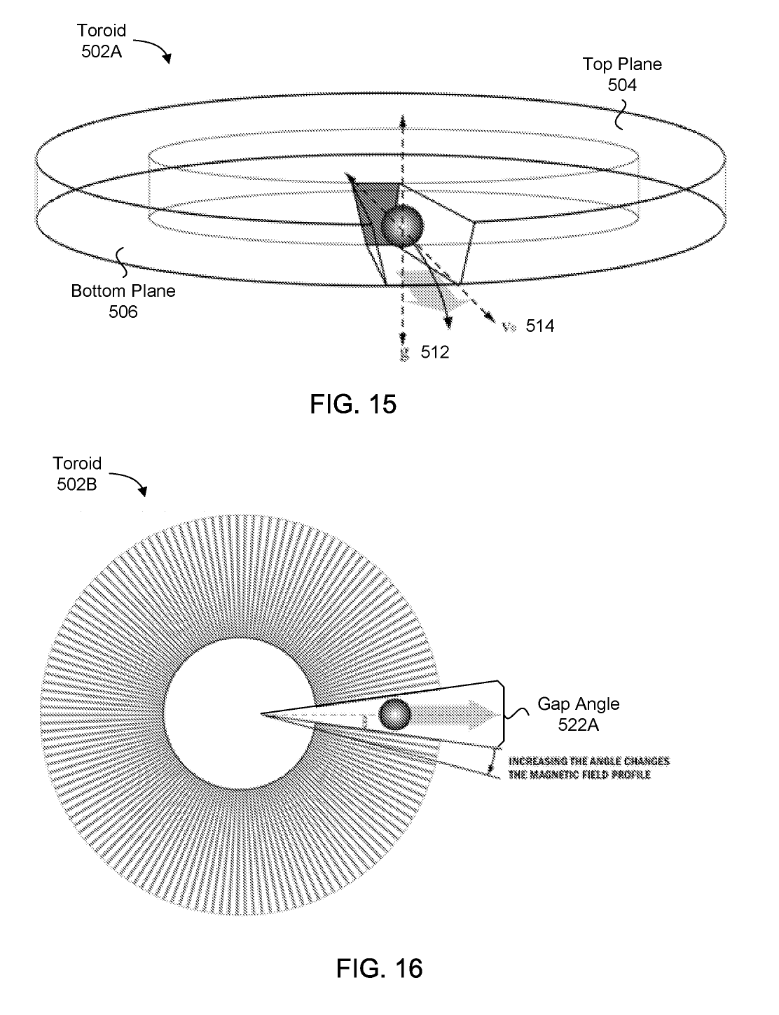

As mentioned, the magnetic core can have various geometries or shapes. The magnetic core also includes a gap (or core gap). The gap is a break or void of core material in a loop forming the magnetic core, as illustrated in FIG. 15. When the eddy current sorter is operational (i.e., AC current flowing through the coils or windings of the magnetic core), a particle 110 is dropped into the gap. The force of gravity g 518 forces the particles downward. When the particle comes near and passes through the gap, another force v₀ 514 acts on the particles based on the magnetic flux field (B-field) acting on the particle and the eddy currents generated in the particle, which forces the particle in an outward and downward position.

As shown and described with reference to FIG. 11, the gap can be a parallel gap 410 between substantially parallel planes or be an angled gap 420 forming an arc-like void between two non-parallel planes with a defined radius and angle. The magnetic core (e.g., toroid 502B) can have a gap defined by gap angle 522A, as illustrated in FIG. 16. In some configurations, the magnetic core includes a flare in the gap defined by a flare angle. FIG. 15 illustrates a gap with both a gap angle and a flare with a flare angle. The gap angle can be the angle of the planes defined by the interface between the void (e.g., air) and the magnetic core where the planes are perpendicular to the top plane 504 and bottom plane. The interface between the void (e.g., air) and the magnetic core can be referred to as the gap face. Each core has two faces—one on each side of the core gap. The interface (i.e., gap face) between the void (e.g., air) and the magnetic core is shown as a smooth surface, for ease of illustration and explanation. In other examples, the interface can have other surfaces or texture (e.g., rough or an array of pyramids). Increasing the gap angle can change the magnetic field (B-field) profile. The flare angle is an angle from the perpendicular plane defined by the top plane 504 and bottom plane 506. In an example, the flare faces upward, so the distance between the gap at the top plane (i.e., upper plane) is greater than the distance between the gap on the bottom plane (i.e., lower plane). The upward facing flare can be used to generate an upward as well as outward force on a particle.

The core gap geometry can be variable and tunable according to the material sizes being sorted, the core material, and a desired field gradient. The core gap geometry along with the electrodynamic sorting circuit can be used to control the magnetic field profile (e.g., a cross sectional distribution of magnetic field intensity) as well as ensure the maximum gradient, which imparts a direction and magnitude to a particle encountering the magnetic field.

The gradient can be tunable according to the gap angle and/or flare angle (and the core material). Models can be developed to maximize the field strength with a distribution where some particles will fall through the gap while maintaining the gradient required to direct and deflect the particle in the desired direction.

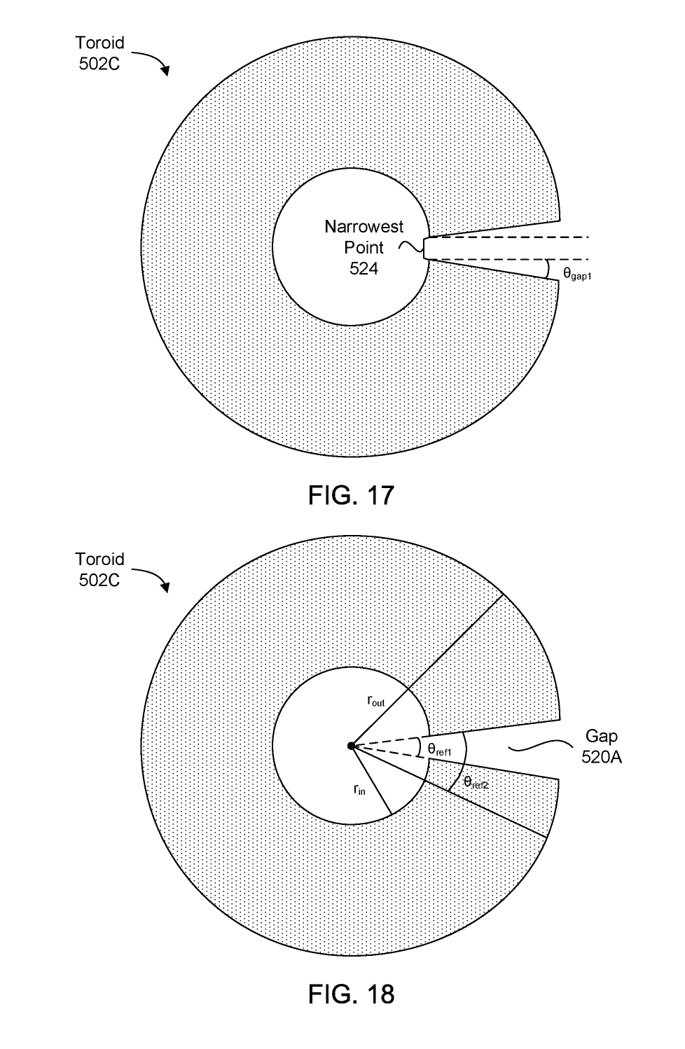

FIGS. 17-20 illustrate various top views of the core gap and the core gap angle of a toroid 502C-E. The gap of the magnetic core forms a wedged frustum-like shaped void where the top view of the wedged shaped void forms an arc with a radius and an angle. The core gap angle can be defined in various ways. For example, in FIG. 17, the core gap angle is defined from parallel planes extending from the narrowest point 524 of the gap 520. The core gap angle θ_{gap1} is the angle between the imagery parallel plane touching the narrowest point 324 of the gap-magnetic core boundary and a gap face.

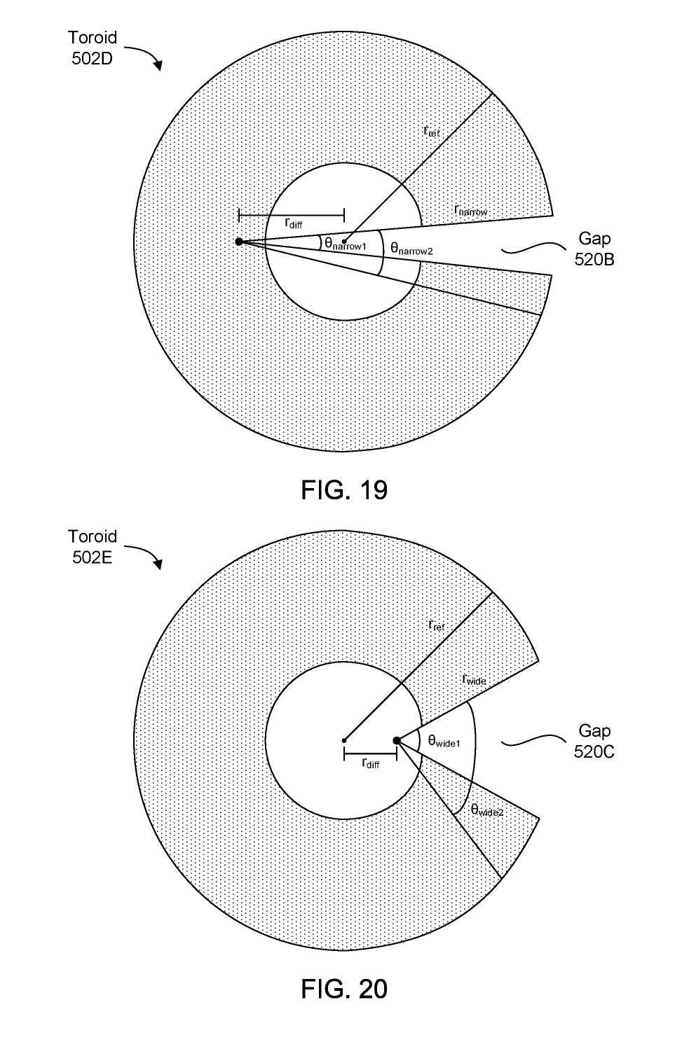

In another example shown in FIG. 18, the core gap 520A is defined by an arc of the wedged frustum-like shaped void with a radius rₒᵤₜ and an angle θ_{ref1} (or θ_{ref2}). The inner concentric circle of the toroid 502C can have a radius rₘ and the outer concentric circle of the toroid 502C can have a radius rₒᵤₜ or r_{ref}. The radius of the gap can be greater than r_{ref} (e.g., r_{narrow} in FIG. 18 [i.e., r_{narrow}=r_{ref}+r_{diff}]), greater than equal to r_{ref} (e.g., rₒᵤₜ in FIG. 18 [i.e., rₒᵤₜ=r_{ref} and r_{diff}=0]), or less than r_{ref} (e.g., r_{wide} in FIG. 20 [i.e., r_{wide}=r_{ref}−r_{diff}]). FIG. 19 shows the core gap 520B is defined by an arc of the wedged frustum-like shaped void with the radius r_{narrow} and an angle θ_{narrow1} (or θ_{narrow2}). FIG. 20 shows the core gap 520C is defined by an arc of the wedged frustum-like shaped void with the radius r_{wide} and an angle θ_{wide1} (or θ_{wide2}).

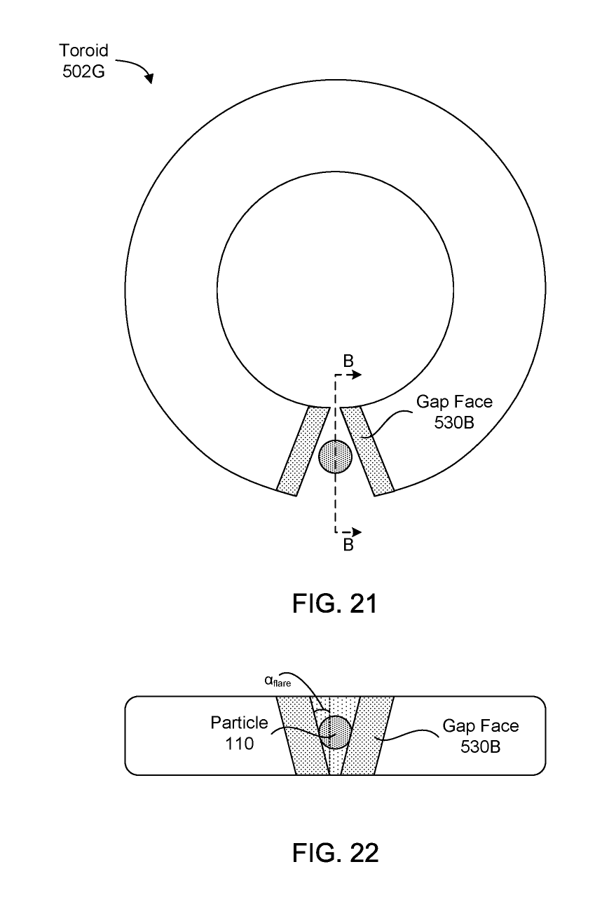

As previously discussed, in some configurations, the magnetic core also includes a flare. FIGS. 21-22 illustrates a core gap with a flare including gap faces 530B that are not perpendicular to the top plane and the bottom plane of the toroid 502G. The flare angle α_{flare} is an angle of the gap face relative to a plane perpendicular to the top plane and the bottom plane of the toroid 502F (e.g., a vertical plane). As previously discussed, the upward facing flare can be used to generate an upward as well as outward force on a particle. The flare angle α_{flare} depends on the material sizes being sorted, the core material, and a desired field gradient (including the desired upward force and the desired outward force).

The shape and dimensions of the plane geometrical figure and/or gap face can affect the magnetic gradient of the magnetic core, force generated by the magnetic core, trajectory of the particles from the magnetic core, and/or efficiency of the magnetic core.

Additional Gap Designs

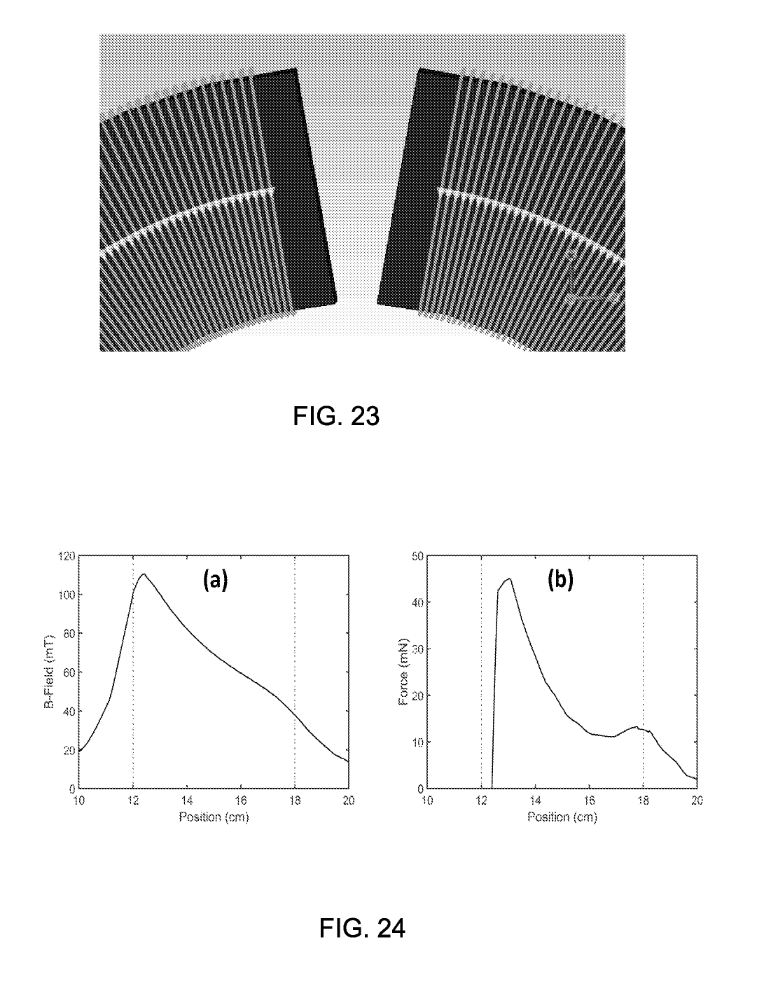

Begin by considering the simple gapped core depicted in FIG. 23. The gap geometry is a V-cut, which is simply defined by an apex distance at the inner radius and a flare angle to the outer radius. For a particular example, the inner radius is 12 cm and the outer radius is 18 cm. The apex distance is likewise 1.0 cm with a flare angle of 10 degrees. FIG. 24A shows the corresponding magnetic field profile generated from numerical simulation. FIG. 24B then shows us the force profile for a copper sphere with diameter 1.0 cm excited at 5.0 kHz.

As the figure shows, most of the force is packed tightly towards the rear of the gap and then decays rapidly in position away from the apex. This kind of profile is generally undesirable, in some constructions, as random perturbations in the particle insertion can potentially lead to drastic variations in deflected trajectories. It also creates large regions of relatively weak forces, such that a particle is more likely to just fall directly through the gap rather than exhibit any significant deflection.

In order to better control the force profile acting through the magnetic gap, one can either shape the field intensity B₀, or the field slope dB/dx. However, the only mechanism to control these parameters is the gap spacing at some particular radius value. Narrower spacing tends to increase B₀, while wider spacing tends to reduce it. Also the spacing needs to monotonically increase, or else the slope might suddenly change sign. This would have the effect of pulling the particle back into the gap rather than eject it. Consequently, if one wishes to shape the force profile more efficiently, our only option is to control the rate at which the gap widens. Greater are angles have the effect of increasing dB/dx, thus producing a much greater force than would have been otherwise.

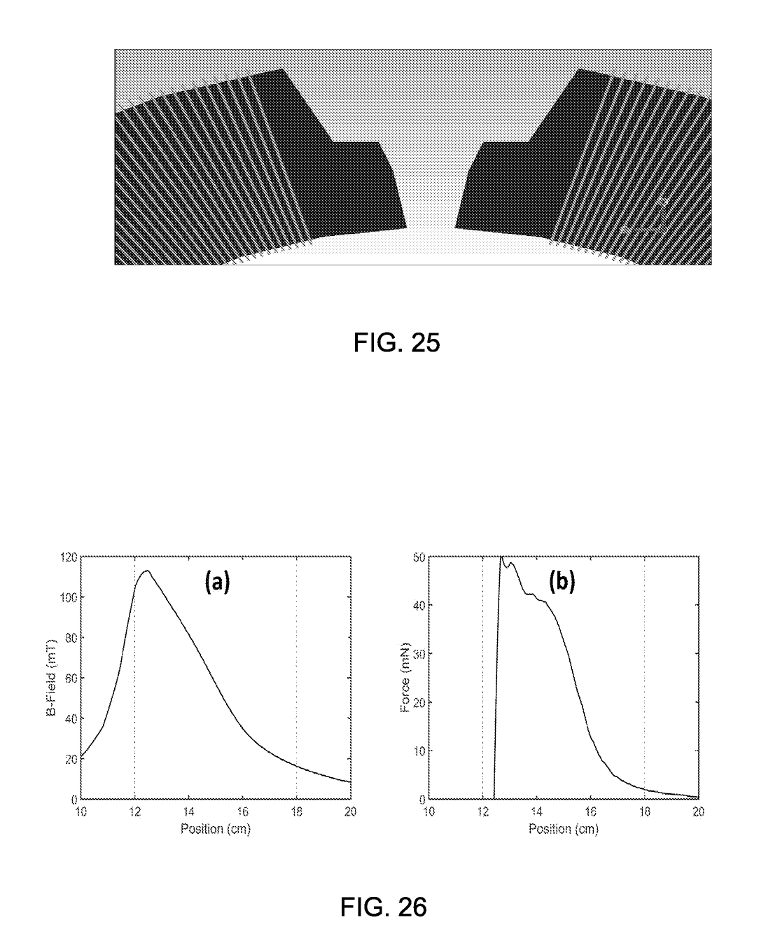

Now consider the gap geometry in FIG. 25. Rather than a single cut with a single are angle, the gap is cut into three segments. The first segment is just like the V-cut, with an apex distance of 1.0 cm and a flare angle of 10 degrees. After 2.0 cm, the next segment then slightly widens the flare angle out to 20 degrees. Finally, 1.0 cm later, there is a sudden discontinuity out to 5.0 cm. FIG. 26 shows the resulting field profiles.

Looking closely at FIG. 26B, the field profile has been greatly compressed into the reduced gap area. Through careful choice of parameters, one is able to successfully produce a reasonably constant force of approximately 40 mN before dropping of very suddenly at the third cut. The result is a relatively uniform region of significantly strong forces, per our original design goals. While there is no direct equation to solve in order to generate such a profile, it is quite possible to converge on such an outcome through a reasonable amount of trial, error, and intuition.

Further refinements are also possible along extra dimensions for better feed behavior. For example, one problem that has been experienced is the particles bouncing off the top of the gap without really entering the main field. This tends to introduce significant variability in the trajectories that needs to be mitigated. One contemplated solution is to open the gap along the Y-axis, thereby reducing the repulsive forces on particles falling in.

Voltage Reduction in Magnetic Cores for Electrodynamic Sorting

In practice, it is common to drive the magnetic core by using a series RLC circuit.

This creates a resonant circuit wherein large electrical currents can be achieved through a relatively small drive voltage V. However, no matter how the circuit is arranged, V=L dI/dt always holds true across the terminals of the magnetic core. Depending on the specific parameters of the system, this has the potential to create large voltages across the core wiring.

As an example, consider a typical ferrite core with a total inductance of 80 mH. When driven at a current amplitude of 4.0 A and a frequency of 6.5 kHz, the peak voltage across the windings is found to be over 12 kV. Voltage levels of this magnitude are not preferred, as most copper wiring is only rated to carry perhaps 10 kV or less.

One solution to the problem is to cut the winding into two segments. If the two segments are then driven with equal current magnitude, the net current density around the core remains unchanged, and thus does not perturb the magnetic field within the gap. However, the original series inductor now behaves as two separate inductors connected in parallel. If one assumes that the two coils are perfectly split into equally inductive components at half the original value, then the net inductance across the coil has effectively dropped by a factor of 4. Thus, if one increases the net input current by a factor of 2 (to maintain a consistent B-field), the final voltage across the coils will be reduced by a net factor of 2.

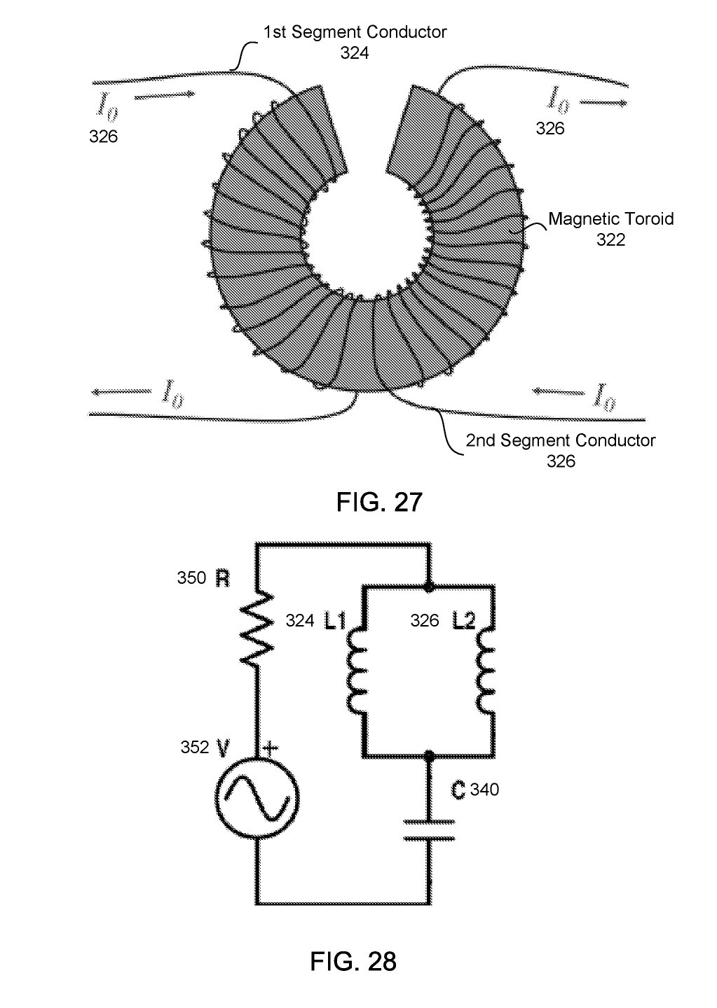

For example, FIG. 27 illustrates a gapped magnetic core (e.g., magnetic toroid 322) of the WWGC with two toroidal winding of electrical conductor 324 (e.g., electrical wire) that can be used in the variable frequency eddy current sorter. As shown in FIG. 27, the magnetic fields are achieved through the use of a first large, toroidal coil segment 324 and a second large tropical coil segment 326 of electrical wire wrapped around a gapped magnetic core or loop, such as the toroidal shaped core 322. When driven with electrical current I, a magnetic field (B-field) is produced within the gap, which is then used to excite eddy currents within conductive particles, such as particles of scrap metal. FIG. 28 show the representative RLC circuit with two conductor coils 324 and 326. . The RLC circuit behaves identically to the one in FIG. 9, but with an equivalent inductance that is significantly reduced. More complex winding segments are envisioned, for example three or four segments all driven in parallel, and it is envisioned that one can use switches to add/remove winding segments.

Speaking generally, segmentation of the windings invokes the trade-offs between voltage and current. One may generalize this result by stating that for n divisions of the wire into equal segments, the voltage across the coils will drop by a factor of n as well. However, this drop is made up for by a proportionate rise in the total current by a factor of n, since each new segment should be fed with the same current in order to maintain a consistent magnetic field. Due to the separate segments of wire around the coil, embodiments now have the option of sharing the current among multiple amplifiers (an option that was not available with a single, series wire under fewer turns). Thus, as long as an embodiment maintains phase consistency among the segments, the embodiment will deliver consistent magnetic field to a scrap particle with less voltage

One challenge to segmentation is making sure that impedances are balanced across each coil. Otherwise, the coil with the lowest impedance will tend to draw a disproportionate amount of current from the other coils. While this does not immediately affect the final magnetic field within the gap, it does place a potential burden on the wiring itself, which must now support a greater current than the neighboring coils. Proper load balancing helps ensure a greater peak value in total current that can be driven through the coils.

Winding Configurations for Electrodynamic Sorting

The primary component of electrodynamic sorting is a core of magnetically permeable material, ideally with a relative permeability μᵣ between 1000-2000. One exemplary core is typically shaped as a rectangular toroid, wrapped up with several dozen turns of copper wiring. A gap then cut away from one end so that scrap particles can be inserted and sorted accordingly. To magnetize the gap, an electrical current is driven through the copper wiring, which then fills the gap with the desired magnetic field. Since the force of repulsion experienced by a particle is directly proportional to the field intensity within the gap, it is preferred, in some embodiments, to generate as much field intensity as possible for maximum separation distance.

In some structures, significant field strength can be added to the magnetic gap by rewiring the core with a specific winding geometry. The basis for this discovery has been the realization that the magnetic field profile within the gap is relatively insensitive to where exactly the windings are placed. For example, ten windings wrapped together at a single location will tend to produce just as much magnetic flux as ten windings distributed uniformly around the core. However, since the magnetic core is comprised of a nonlinear material, the arrangement of wires does have an impact on where the flux is generated and how much headroom exists before saturation occurs. Thus, by placing the wires more efficiently, it is possible to direct a much greater flux into the magnetic gap without prematurely saturating the core inside.

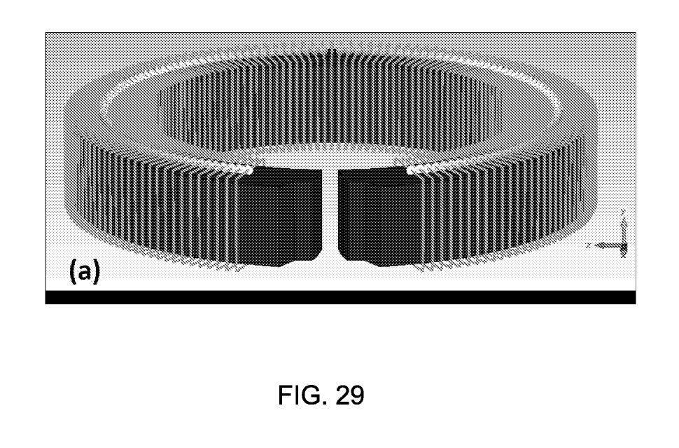

To begin, consider the magnetic core depicted in FIG. 29. In one construction, the core geometry is defined by a rectangular toroid with an outer diameter of 16 cm, an inner diameter of 12 cm, and a height of 2.5 cm. In the front of the core, a specialized gap has been cut out for particles to feed in and be sorted. The core is wound uniformly with 150 turns and driven with a DC electrical current of 3.0 A. Such a configuration represents the typical set of parameters one might employ when engaged in particle sorting between 2-4 mm in size.

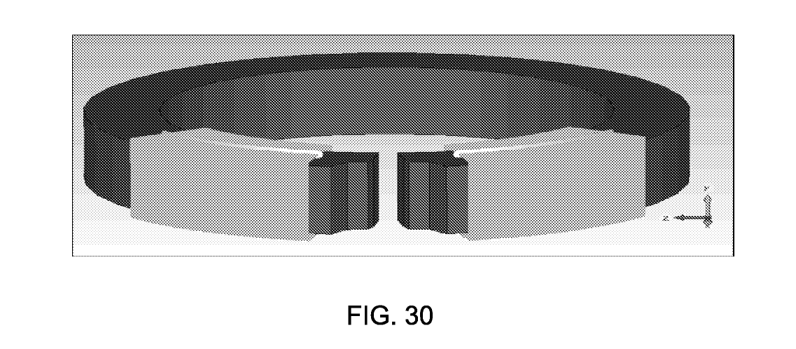

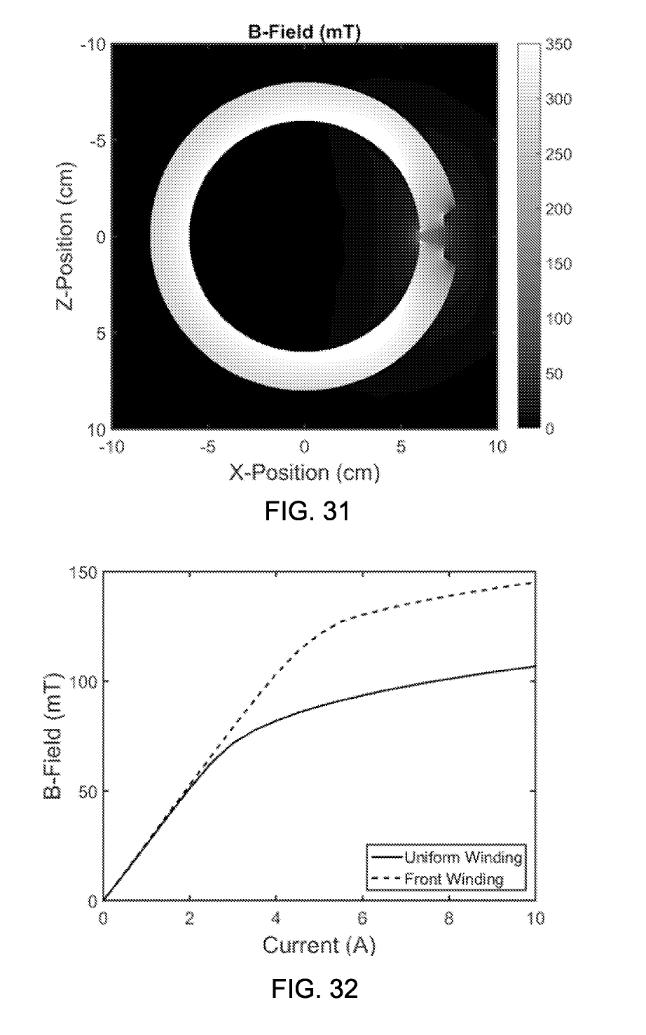

In FIG. 30, the wires have been wrapped around the front of the core as close to the gap as reasonably possible. Because the wiring itself has finite thickness on the order of 1.0 mm, one cannot perfectly wrap all the windings infinitesimally close to the gap. The windings are therefore coiled around the core in 40 degree swaths along each side of the gap to reflect finite limitations. The internal magnetic field intensity at 3.0 A of drive current is illustrated in FIG. 31. The field profile is more uniform throughout the core, with far fewer hot spots to prematurely saturate. This implies a much greater degree of headroom inside the core such that greater field intensity will find its way into the gap.

To measure this headroom, it is useful to compare the saturation profiles shown in

FIG. 32. The data is generated by sampling the magnetic field intensity at a particular point along the gap, in this case x=6.5 cm, and then plotting it as a function of drive current. One can then compare the field intensity against various winding conditions. As the drive current steadily increases, field intensity throughout the core begins to exceed the saturation point of the ferrite. This alters the slope of the B-I curve as less field intensity is extracted with every additional Ampere of current. For the standard, uniform winding, the saturation point appears to occur around 3.5 A with a corresponding field intensity of roughly 80 mT. For the front-winding case, saturation is increased to almost 5.0 A and nearly 120 mT of field; a full 50% improvement over the uniform case.

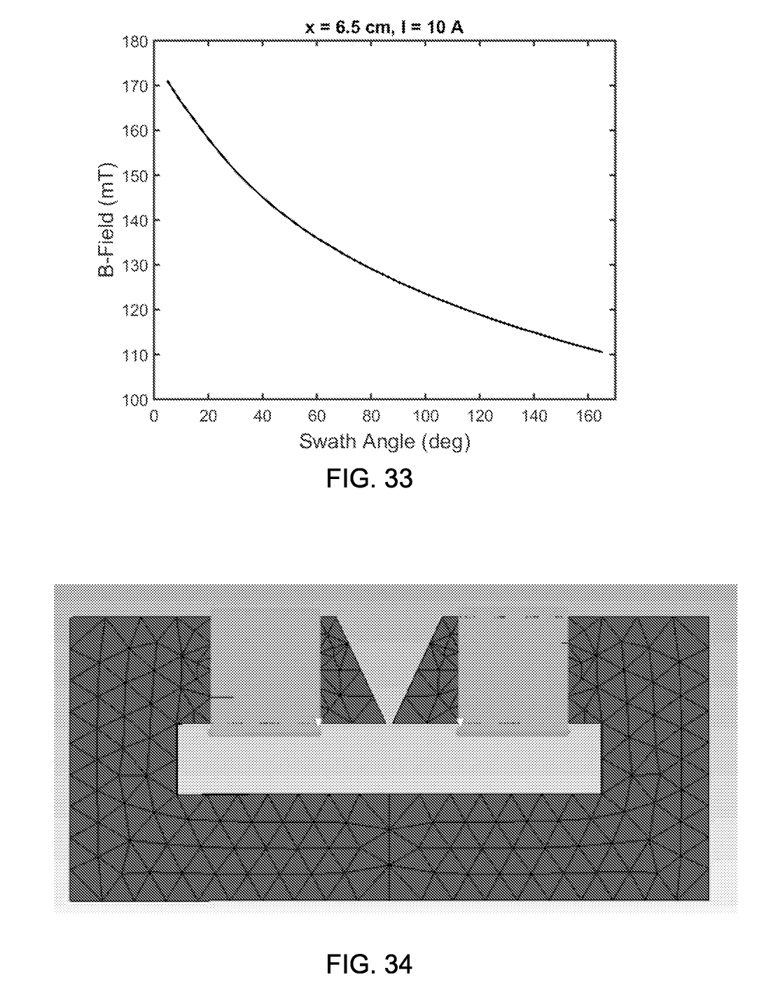

Next, the effect of swath angle on the magnetic field intensity inserted within the gap is considered. First begin by driving the current up to 10 A, which is well-beyond the saturation threshold for the core. That way, any improvement in the saturation headroom will manifest as a greater field intensity inserted into the gap. The swath angle is then varied from 5 degrees to 165 degrees, representing a transition from the highly packed configuration toward the uniform distribution. The result is plotted in FIG. 33, which shows the magnetic field intensity at an arbitrary sample location near the center of the gap. Clearly, one can observe a general increase in magnetic field intensity as the windings are packed closer to the gap. FIG. 34 shows the wires having been wrapped around the front of a rectangular core as close to the gap as possible.

Feeding Mechanism Design

In embodiments, it is may be desirable to feed the materials being sorted in such a manner that irregular shapes are limited from interlocking and clumping. This helps keep the core gap free of obstruction but also maximizes throughput where is a single-file continuous feed. The more uniform the materials being sorted, the higher the throughput as well as higher recovery and grade. It is therefore preferred, in some embodiments, to screen the materials being sorted to ensure uniformity to maximize sorting efficiencies. A second pass of the product can refine grade if initial feed has a wide standard deviation in particle size.

In some embodiments, a feeding mechanism, such as a conveyor or vibratory feeder, has a plastic extension of at least 15 cm or more to minimize field perturbation and loss in close proximity to the magnet.

The feeding system can include a vibratory feeder, a feed chute, and a feed funnel. The feed chute is typically made of non-metallic material is attached to the discharge end of the vibratory feeder. The shown chute has a flat bottom and a 30 degree angled side wall. It is open on the top side and assists in the disentanglement of the material. Also, the nonmetallic material does not conduct eddy current generated by the magnet to the vibratory feeder.

Next, the feed funnel is coupled to the discharge end of the feed chute. The feed funnel can be a square shaped funnel at the top. This design disentangles the scrap feed, helps guide the material into the gap, and overcomes the upward force exerted by the magnet.

In certain embodiments, the feeder is shaped such that the material flows into the attachment that narrows the material into a smaller cross-sectional area to be delivered into the gap.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second and the like may be used solely to distinguish one entity or action from another entity or action without necessarily requiring or implying any actual such relationship or order between such entities or actions. Directional references, such as upper, lower, downward, upward, rearward, bottom, front, rear, etc., may be made herein in describing the drawings, these references are made relative to the drawings (as normally viewed) for convenience. These directions are not intended to be taken literally. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. An eddy current sorter, comprising:
a wire-wound, gapped, core (WWGC) including a magnetic core having a gap and a winding of electrical conductor wound around the magnetic core, the gap for receiving material including a non-ferrous metal;
a variable frequency drive for generating a variable frequency voltage;
a tunable capacitor array electrically coupled in series between the winding and the variable frequency drive; and
an electrical circuit including the variable frequency drive, the tunable capacitor array, and the winding, the electrical circuit for producing a varying magnetic field with a frequency to deflect the non-ferrous metal from the material,
wherein the resonant frequency is selected and the tunable capacitor array is tuned for significant sorting of materials based on an electrical conductivity, mass density, and particle geometry.

15. The eddy current sorter of claim 14, further comprising an ammeter coupled between the signal generator and the tunable capacitor array.

16. The eddy current sorter of claim 14, wherein the tunable capacitor array includes high voltage capacitors switchable to generate a specified capacitance for the WWGC.

17. The eddy current sorter of claim 14, wherein the winding includes a first winding and a second winding.

18. The eddy current sorter of claim 17, wherein the first winding and the second winding are electrically coupled in a parallel circuit relationship.

19. The eddy current sorter of claim 17, wherein the electrical conductor is coiled around a quarter section of the magnetic core on each side of the gap.

20. The eddy current sorter of claim 14, further comprising a vibratory feeder and a conveyor belt to move the material towards the gap of the magnetic core.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. An eddy current sorter, comprising:
a wire-wound, gapped, core (WWGC) including a magnetic core having a first end and a second end, the first and second ends defining a gap, and a winding of electrical conductor wound around the core, the winding having a first winding segment and a second winding segment, the first winding segment and the second winding segment are electrically coupled in a parallel circuit relationship, the first winding segment being packed on a first side of the gap and the second winding segment being packed on a second side of the gap, the gap for receiving material including a non-ferrous metal;
an electrical circuit including a variable frequency drive, a resonator capacitor, and a winding, the electrical circuit for producing a varying magnetic field with a frequency to deflect the non-ferrous metal from the material;
a conveyer for delivering the material to the gap of the WWGC; and
a collection assembly for separating material with different trajectories from the WWGC.

35. The eddy current sorter of claim 34, further comprising a vibratory feeder including a hopper for holding the material, the conveyer to receive the material for delivery, and a vibrator coupled to the hopper.

36. The eddy current sorter of claim 34, wherein the electrical circuit generates a resonant frequency intended for substantial deflection between at least two materials to be sorted.

37. The eddy current sorter of claim 34, wherein the magnetic core includes a shape having a first straight length, a second straight length perpendicular to the first strait length, and a third straight length perpendicular to the first straight length, the second straight length being parallel to the third straight length.

38. The eddy current sorter of claim 34, wherein the magnetic core includes a magnetic toroid.

39. The eddy current sorter of claim 34, wherein the magnetic toroid is a ring torus or ring toroid.

40. The eddy current sorter of claim 34, wherein the gap forms a frustum-shaped void in the magnetic toroid.

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. An eddy current sorter, comprising:
a wire-wound, gapped, core (WWGC) including a magnetic core having a first end and a second end, the first and second ends defining a gap, the gap for receiving material including a non-ferrous metal, the first end having a first surface and a second surface, the first and second surfaces having an edge between the first and second surfaces, the second end has a third surface and a fourth surface, the third and fourth surfaces having an edge between the third and fourth surfaces, wherein the third surface mirrors the first surface and the fourth surface mirrors the second surface, the WWGC further including a winding of electrical conductor wound around the magnetic core;
an electrical circuit including a variable frequency drive, a resonator capacitor, and a winding, the electrical circuit for producing a varying magnetic field with a frequency to deflect the non-ferrous metal from the material; and
a collection assembly for separating material with different trajectories from the WWGC.

54. The eddy current sorter of claim 53, wherein the first end includes a fifth surface, the second and fifth surfaces have a second edge between the second and fifth surfaces.

55. The eddy current sorter of claim 53, wherein the electrical circuit generates a resonant frequency intended for substantial deflection between at least two materials to be sorted.

56. The eddy current sorter of claim 53, wherein the winding includes a first winding segment and a second winding segment.

57. The eddy current sorter of claim 56, wherein the first winding segment and the second winding segment are electrically coupled in a parallel circuit relationship.

58. The eddy current sorter of claim 56, wherein first winding is packed on a first side of the gap and the second winding is packed on a second side of the gap.
